(19) United States
(12) Patent Application Publication
(10) Pub. No.: US 2015/0332806 A1
(43) Pub. Date: Nov. 19, 2015

(54) CURABLE RESIN COMPOSITION, INSULATING FILM, PREPREG, CURED PRODUCT, COMPOSITE, AND SUBSTRATE FOR ELECTRONIC MATERIAL

(71) Applicant: ZEON CORPORATION, Tokyo (JP)

(72) Inventors: Shuhei Hayakawa, Chiyoda-ku, Tokyo (JP); Yuki Hayashi, Chiyoda-ku, Tokyo (JP)

(73) Assignee: ZEON CORPORATION, Tokyo (JP)

(21) Appl. No.: 14/651,913

(22) PCT Filed: Dec. 10, 2013
(86) PCT No.: PCT/JP2013/007271

§ 371 Date: Jun. 12, 2015

(30) Foreign Application Priority Data
Dec. 13, 2012 (JP) 2012-272650
Dec. 13, 2012 (JP) 2012-272666

(51) Int. Cl. H01B 3/40; C08K 3/36; B32B 27/20; B32B 27/38; B32B 27/32; B32B 27/12; C08J 5/18; B32B 27/08

(52) U.S. Cl. CPC H01B 3/40; C08J 5/18; C08K 3/36; B32B 27/08; B32B 27/38; B32B 27/325; B32B 27/12; B32B 27/20; C08J 2323/26; C08J 2463/00; B32B 2307/206; B32B 2250/24

(57) ABSTRACT

Disclosed is a curable resin composition including: a phosphorus-containing epoxy compound (A2) having a structure represented by formula (1) or (2) below; and a filler (A3),

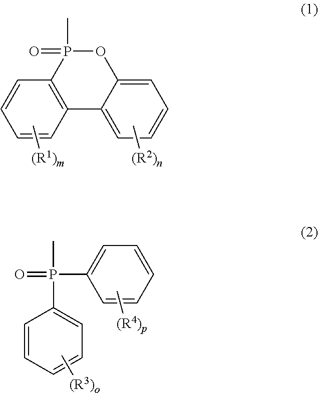

where in the formula (1), R¹ and R² each independently represent a hydrocarbon group having 1 to 6 carbon atoms, and m and n each independently represent an integer of 0 to 4, R¹s may be the same or different when m is 2 or more, and R²s may be the same or different when n is 2 or more, and
where in the formula (2), R³ and R⁴ each independently represent a hydrocarbon group having 1 to 6 carbon atoms, and o and p each independently represent an integer of 0 to 5, R³s may be the same or different when o is 2 or more, and R⁴s may be the same or different when p is 2 or more.

### CROSS-REFERENCE TO RELATED APPLICATIONS

This application claims priority to and the benefit of Japanese patent application No. 2012-272650 filed Dec. 13, 2012, and Japanese patent application No. 2012-272666 filed Dec. 13, 2012, the entire contents of which are incorporated herein by reference in their entirety.

This disclosure relates to curable resin compositions, insulating films, prepregs, cured products, composites, and substrates for electronic material.

### BACKGROUND

### Technical Field

With the constant pursuit of miniaturization, more functionality, and higher communication speed of electronics, there is increasing demand for ever-denser circuit boards used in semiconductor devices of electronics. To meet the demand, circuit boards with multilayer structure (hereinafter, “multilayer circuit boards”) have been used.

Such a multilayer circuit board is formed by, for example, stacking an electrically insulating layer on an inner substrate composed of an electrically insulating layer and a conductor layer formed on a surface thereof, forming a conductor layer on the electrically insulating layer, and by repeating this cycle of stacking of an electrically insulating layer and forming of a conductor layer. In this regard, an insulating film that is used to form an electrically insulating layer of a multilayer circuit board is required to have good electrical properties. Therefore, in recent years, as candidates for such insulating films, those films that are formed using a resin composition containing an alicyclic olefin polymer and exhibit excellent electrical properties have been studied. A film of this kind using an alicyclic olefin polymer, however, has indeed excellent electrical properties such as small dielectric loss tangent, yet sometimes shows insufficient flame retardancy. Thus, to compensate for insufficient flame retardancy, techniques pertaining to addition of various flame retardants have been developed. For example, one such technique is described in JP201084026A (PTL 1), which is directed to a curable resin composition obtained by blending an alicyclic olefin polymer, which has a weight-average molecular weight of 10,000 to 250,000, and which has a carboxyl group or acid anhydride group, with a curing agent and a phosphazene compound having a specific structure as a flame retardant. An electrically insulating layer (cured product) that is formed by curing the curable resin composition described in PTL 1 is excellent in flame retardancy, easy to form a conductor layer thereon with a fine circuit pattern by plating on its surface, and exhibits excellent close adherence to the conductor layer formed on the surface.

### CITATION LIST

### Patent Literature

PTL 1: JP201084026A

In this connection, as flame retardancy requirements become increasingly stringent for insulating films, simply adding a flame retardant may not impart sufficient flame retardancy to electrically insulating layers formed by curing a curable resin composition. Another problem arises, however, when a flame retardant is added in sufficient amounts to a curable resin composition for guaranteeing adequate flame retardancy, as the flame retardant added in such amounts may negatively affect the heat resistance and peel strength of the resulting electrically insulating layer. In other words, it is difficult for an electrically insulating layer that is formed with an insulating film composed of a conventional curable resin composition to have excellent flame retardancy, heat resistance, and peel strength all at the same time.

In recent years, attempts have been made to provide a well-balanced, electrically insulating layer with various properties, by forming an insulating film that is obtained by stacking multiple layers made of resin compositions different from one another. Such an insulating film with multilayer structure is also required to guarantee flame retardancy, heat resistance, and peel strength of the resulting electrically insulating layer at the same time.

It could thus be helpful to provide a curable resin composition from which a cured product having excellent electrical properties and being excellent in all of flame retardancy, heat resistance, and peel strength, can be formed, and a cured product thereof.

It could also be helpful to provide an insulating film and prepreg with multilayer structure from which an electrically insulating layer having excellent electrical properties and being excellent in all of flame retardancy, heat resistance, and peel strength can be formed, a cured product thereof, and a composite with the cured product.
It could also be helpful to provide a substrate for electronic material containing, as a constituent material, the aforementioned cured product formed by curing the curable resin composition, or the aforementioned composite.

### SUMMARY

We discovered that a curable resin composition may be prepared by using an alicyclic olefin polymer having a polar group, a phosphorus-containing epoxy compound having a specific structure, and a filler, thereby providing a cured product formed from the curable resin composition with excellent electrical properties, as well as excellent flame retardancy, heat resistance, and peel strength. Further, upon use of an insulating film stacked on a substrate such as an inner substrate, we discovered that when at least one layer of the insulating film having a multilayer structure is obtained by blending an alicyclic olefin polymer having a polar group, a phosphorus-containing epoxy compound having a specific structure, and a filler, a cured product (an electrically insulating layer) formed from the insulating films may have excellent electrical properties, as well as excellent flame retardancy, heat resistance, and peel strength. Based on the discoveries, our products were made.

We thus provide [1] to [14] below.

[1] A curable resin composition comprising:

a polar group-containing alicyclic olefin polymer (A1);

a phosphorus-containing epoxy compound (A2) having a structure represented by formula (1) or (2) below; and

a filler (A3),

Formulas (1) and (2)

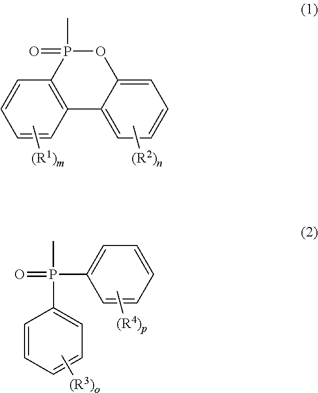

Where in the formula (1), R¹ and R² each independently represent a hydrocarbon group having 1 to 6 carbon atoms, and m and n each independently represent an integer of 0 to 4, R¹s may be the same or different when m is 2 or more, and R²s may be the same or different when n is 2 or more, and

where in the formula (2), R³ and R⁴ each independently represent a hydrocarbon group having 1 to 6 carbon atoms, and o and p each independently represent an integer of 0 to 5, R^{a}s may be the same or different when o is 2 or more, and R⁴s may be the same or different when p is 2 or more.

Thus, the use of the curable resin composition that is obtained by blending the polar group-containing alicyclic olefin polymer (A1), the phosphorus-containing epoxy compound (A2), and the filler (A3), may guarantee flame retardancy of the cured product formed from the curable resin composition, without using large amounts of flame retardant. Therefore, with this curable composition, it is possible to provide a cured product that has not only excellent electrical properties, but also excellent flame retardancy, heat resistance, and peel strength.

[2] The curable resin composition, wherein the phosphorus-containing epoxy compound (A2) is the phosphorus-containing epoxy compound having the structure represented by the formula (1).

In this manner, the use of the phosphorus-containing epoxy compound having the structure represented by the formula (1) as the phosphorus-containing epoxy compound (A2) may provide the resulting cured product with excellent electrical properties, flame retardancy, heat resistance, and peel strength.

[3] The curable resin composition, wherein the polar group of the polar group-containing alicyclic olefin polymer (A1) is at least one selected from the group consisting of a carboxyl group, a carboxylic anhydride group, a phenolic hydroxyl group, and an epoxy group.

In this manner, the use of the polar group-containing alicyclic olefin polymer (A1) is advantageous in that a cured product obtained by reaction with the epoxy structure of the phosphorus-containing epoxy compound (A2) exhibits excellent mechanical strength and heat resistance.

[4] The curable resin composition, wherein the polar group-containing alicyclic olefin polymer (A1) has a polar group reactive with an epoxy structure contained in the phosphorus-containing epoxy compound (A2).

In this manner, when the polar group of the polar group-containing alicyclic olefin polymer (A1) is a group reactive with an epoxy structure in the phosphorus-containing epoxy compound (A2), the resulting cured product may have excellent electrical properties, flame retardancy, heat resistance, and peel strength.

[5] The curable resin composition, wherein the content of the phosphorus-containing epoxy compound (A2) is 50 parts by mass to 90 parts by mass per 100 parts by mass of the polar group-containing alicyclic olefin polymer (A1).

In this manner, when the content of the phosphorus-containing epoxy compound (A2) is 50 parts by mass or more per 100 parts by mass of the alicyclic olefin polymer (A1), it is possible that a cured product formed from the curable resin composition may exhibit sufficiently high flame retardancy. In addition, when the content of the phosphorus-containing epoxy compound (A2) is 90 parts by mass or less per 100 parts by mass of the alicyclic olefin polymer (A1), it is possible to highly balance the electrical properties of the cured product and the peel strength of a plating layer, which is provided on a surface of the cured product, between the plating layer and the cured product.

[6] The curable resin composition, wherein a phosphorus content is 0.8 mass % to 5 mass %, the phosphorus content being expressed as the mass of phosphorus atoms in the curable resin composition divided by the mass calculated by subtracting the mass of the filler (A3) from the mass of solids in the curable resin composition.

In this manner, when the phosphorus content is within the aforementioned range, the resulting cured product may exhibit excellent flame retardancy as well as excellent electrical properties.

[7] A cured product formed by curing the curable resin composition.

With the aforementioned curable resin composition, it is possible to provide a cured product that has not only excellent electrical properties, but also excellent flame retardancy, heat resistance, and peel strength. Note that the cured product is not particularly limited as long as it is formed by curing our curable resin composition, and examples thereof include a product that is obtained by curing a molded product formed by molding our curable resin composition into a sheet- or film-like form, a product that is obtained by curing a prepreg formed by impregnating a fibrous substrate with our curable resin composition, a product that is obtained by curing a laminate formed by stacking the molded product or the prepreg on a substrate.

[8] An insulating film comprising:

a resin layer 1 made of the curable resin composition; and

a resin layer 2 made of another curable resin composition.

The insulating film having the resin layer 1 made of the aforementioned curable resin composition exhibits, when provided as a cured product, excellent electrical properties, as well as excellent flame retardancy, heat resistance, and peel strength.

[9] The insulating film, wherein the resin layer 1 is a plateable layer and the resin layer 2 is an adhesive layer.

Further, upon use of an insulating film stacked on an inner substrate and the like, and having a multilayer structure composed of an adhesive layer adhered to a surface of a substrate constituting the inner substrate and the like, and a plateable layer having a surface on which a conductor layer is formed, the use of the aforementioned curable resin composition for the plateable layer provides a cured product of the insulating film with excellent electrical properties, as well as excellent flame retardancy, heat resistance, and peel strength. The cured product may also be well stacked via the adhesive layer on a surface of a substrate such as an inner substrate.

[10] The insulating film, wherein the resin layer 1 made of the curable resin composition has a thickness of 1 μm to 10 μm, and the resin layer 2 made of the other curable resin composition has a thickness of 5 μm to 100 μm.

When the thickness of the resin layer 1 made of the curable resin composition is within the aforementioned range, it is possible to reduce linear expansion of a cured product formed by curing the insulating film.
In particular, when the resin layer 1 is a plateable layer and the resin layer 2 is an adhesive layer, linear expansion of the cured product may be reduced by setting the thickness of the plateable layer within the aforementioned range, and a conductor layer may be easily formed on a cured product formed by curing the insulating film. In addition, by setting the thickness of the adhesive layer within the aforementioned range, the insulating film may have good wire embeddability, the thickness of the electrically insulating layer formed by curing our insulating film may be sufficiently small, and, as a result, the thickness of the substrate provided with the electrically insulating layer may be reduced.
Moreover, since the plateable layer has high flame retardancy as mentioned above, when the plateable layer is increased in thickness relative to the adhesive layer, the flame retardancy of the electrically insulating layer formed by curing the insulating film may improve as a whole. Conversely, when the adhesive layer is increased in thickness relative to the plateable layer, and if the adhesive layer has excellent properties including heat resistance, wire embeddability, and surface flatness, the electrically insulating layer formed by curing the insulating film as a whole may benefit from improved properties originating from the aforementioned adhesive layer. Further, for example, in the case of forming an insulating film having a plateable layer with a relatively small filler content and an adhesive layer with a relatively large filler content, the linear expansion coefficient generally decreases with increasing filler content and, consequently, it is possible to reduce the linear expansion coefficient of the electrically insulating layer formed by curing the insulating film as a whole by increasing the thickness of the adhesive layer relative to the plateable layer.

[11] A prepreg comprising:

a plateable layer made of a plateable layer-use resin composition containing a polar group-containing alicyclic olefin polymer (A1), a phosphorus-containing epoxy compound (A2) having the structure represented by the formula (1) or (2) above, and a filler (A3);

an adhesive layer made of an adhesive layer-use resin composition; and

a fibrous substrate.

In this manner, a prepreg that has a plateable layer made of a resin composition obtained by blending the polar group-containing alicyclic olefin polymer (A1), the phosphorus-containing epoxy compound (A2) having the structure represented by the formula (1) or (2), and the filler (A3), exhibits, when provided as a cured product, excellent electrical properties, as well as excellent flame retardancy, heat resistance, and peel strength. The cured product may also be well stacked via the adhesive layer on a surface of a substrate such as an inner substrate.

[12] A cured product formed by curing the insulating film or the prepreg.

In this manner, by curing the aforementioned insulating film or prepreg, a cured product having excellent flame retardancy, heat resistance, and peel strength may be provided.
Note that the cured product is not particularly limited as long as it is obtained by curing our insulating film or prepreg, and examples thereof include a product formed by curing a laminate having the insulating film or prepreg stacked on a substrate.

[13] A composite comprising a conductor layer formed on a surface of the cured product formed by curing the insulating film or the prepreg.

The use of the aforementioned insulating film or prepreg may provide a composite exhibiting excellent electrical properties, as well as excellent flame retardancy, heat resistance, and peel strength.

[14] A substrate for electronic material comprising, as a constituent material, the cured product formed by curing the curable resin composition, or the composite.

Such a substrate for electronic material that contains the cured product or the composite as a constituent material may be suitably used for a variety of electronics.

Note that “the polar group-containing alicyclic olefin polymer (A1)” may be abbreviated herein as “the alicyclic olefin polymer (A1),” and “the phosphorus-containing epoxy compound (A2) having the structure represented by the formula (1) or (2)” may be abbreviated herein as “the phosphorus-containing epoxy compound (A2),” as deemed appropriate.

According to this disclosure, it is possible to provide a curable resin composition from which a cured product having excellent electrical properties and being excellent in all of flame retardancy, heat resistance, and peel strength, can be formed, and a cured product thereof.

According to the disclosure, it is also possible to provide an insulating film and prepreg with multilayer structure from which an electrically insulating layer having excellent electrical properties and being excellent in all of flame retardancy, heat resistance, and peel strength can be formed, a cured product thereof, and a composite with the cured product.
According to the disclosure, it is also possible to provide a substrate for electronic material containing, as a constituent material, the aforementioned cured product obtained by curing the curable resin composition, or the aforementioned composite.

### DETAILED DESCRIPTION

Embodiments of our products will be further described below. Where a numerical range is disclosed herein using the term “to,” such range is inclusive of both the minimum and maximum values preceding and following the term, respectively.

Our curable resin composition comprises: the polar group-containing alicyclic olefin polymer (A1); the phosphorus-containing epoxy compound (A2) having the structure represented by the formula (1) or (2); and the filler (A3).

<Polar Group-Containing Alicyclic Olefin Polymer (A1)>

The polar group-containing alicyclic olefin polymer (A1) disclosed herein has an alicyclic structure in some or all of the monomer units, and has at least one polar group in the polymer molecule. With an alycyclic structure, a cured product obtained from the curable resin composition exhibits good electrical properties and, through the reaction of the polar group with the epoxy structure (epoxy group) of the phosphorus-containing epoxy compound (A2), the resulting cured product may have improved mechanical strength.

Examples of the alicyclic structure of the alicyclic olefin polymer (A1) include a cycloalkane structure and a cycloalkene structure; a cycloalkane structure is preferred from the perspective of mechanical strength, heat resistance, and so on, of a cured product obtained by curing a curable composition containing the alicyclic olefin polymer (A1). In addition, examples of the alicyclic structure include, but are not particularly limited to, monocyclic, polycyclic, fused polycyclic, bridged cyclic structures, and polycyclic structures resulting from a combination thereof. The number of carbon atoms constituting such alicyclic structure is not particularly limited, yet normally 4 to 30 carbon atoms, preferably 5 to 20 carbon atoms, and more preferably 5 to 15 carbon atoms. It is preferable to set the number of carbon atoms constituting the alicyclic structure within this range, because the properties of mechanical strength, heat resistance, and formability can be highly balanced. In addition, the alicyclic olefin polymer (A1) is normally thermoplastic, yet may exhibit thermosetting properties when used in combination with a curing agent (containing the phosphorus-containing epoxy compound (A2)).

The alicyclic structure of the alicyclic olefin polymer (A1) is made of olefin monomer units having an alicyclic structure formed by carbon atoms, i.e., alicyclic olefin monomer units. The alicyclic olefin polymer (A1) may contain other monomer units in addition to alicyclic olefin monomer units. The percentage of the alicyclic olefin monomer units in the alicyclic olefin polymer (A1) is not particularly limited, yet normally 30 mass % to 100 mass %, preferably 50 mass % to 100 mass %, and more preferably 70 mass % to 100 mass %. When the percentage of alicyclic olefin monomer units is 30 mass % or more, the resulting cured product exhibits excellent heat resistance. Monomer units other than the alicyclic olefin monomer units are not particularly limited, and selected as appropriate for the purpose.

The polar group contained in the alicyclic olefin polymer (A1) is not particularly limited, and examples thereof include an alcoholic hydroxyl group, a phenolic hydroxyl group, a carboxyl group, an alkoxyl group, an epoxy group, a glycidyl group, an oxycarbonyl group, a carbonyl group, an amino group, an ester group, a carboxylic anhydride group, a sulfonate group, and a phosphate group. Among these, the polar group contained in the alicyclic olefin polymer (A1) is preferably at least one selected from the group consisting of carboxyl group, carboxylic anhydride group, phenolic hydroxyl group, and epoxy group, from the perspective of the cured product obtained by reaction with the epoxy structure of the phosphorus-containing epoxy compound (A2) exhibiting excellent mechanical strength and heat resistance. Note that the alicyclic olefin polymer (A1) may contain one or more types of polar groups.

In addition, the polar group of the alicyclic olefin polymer (A1) may be bonded directly, or via another divalent group, such as a methylene group, an oxy group, an oxycarbonyl oxyalkylene group, or a phenylene group, to atoms constituting the main chain of the polymer. The content of monomer units having a polar group in the alicyclic olefin polymer (A1) is not particularly limited, yet is preferably 4 mol % or more, more preferably 8 mol % or more, and preferably 60 mol % or less, and preferably 50 mol % or less, per 100 mol % of the total of monomer units constituting the alicyclic olefin polymer (A1).

Note that the alicyclic olefin polymer (A1) disclosed herein may have an aromatic ring, in addition to the polar group and alicyclic structure. One reason is that when an aromatic ring-containing alicyclic olefin polymer having a polar group is used as the alicyclic olefin polymer (A1), the rigidity of the curable resin composition increases and the strength of a film formed by using the curable resin composition increases. Another reason is that an aromatic-ring-containing alicyclic olefin polymer having a polar group has excellent compatibility with other compounds that may be blended into the curable resin composition.

Further, the alicyclic olefin polymer (A1) disclosed herein may be obtained by, for example, the following methods: (1) polymerizing an alicyclic olefin having a polar group, with the addition of another monomer if necessary; (2) copolymerizing an alicyclic olefin not having a polar group with a monomer having a polar group; (3) polymerizing an aromatic olefin having a polar group, with the addition of another monomer if necessary, and hydrogenating an aromatic ring portion of the resulting polymer; (4) copolymerizing an aromatic olefin not having a polar group with a monomer having a polar group, and hydrogenating an aromatic ring portion of the resulting polymer; or (5) introducing a compound having a polar group to an alicyclic olefin polymer not having a polar group by modification reaction; or (6) for an alicyclic olefin polymer having a polar group (for example, a carboxylic ester group) as obtained by any of the methods (1) to (5), converting the polar group to another polar group (for example, a carboxyl group) by, for example, hydrolysis. Among these, from the perspective of the ability to introduce a polar group to an alicyclic olefin polymer efficiently under simple reaction conditions, a polymer obtained by the method (1) is preferred. In addition, as a polymerization method to obtain the alicyclic olefin polymer (A), for example, ring-opening polymerization or addition polymerization is used. In the case of addition polymerization, the resulting ring-opened polymer preferably undergoes hydrogenation. An aromatic ring-containing alicyclic olefin polymer having a polar group may be obtained by, for example: (7) polymerizing an aromatic ring-containing alicyclic olefin having a polar group, as the alicyclic olefin having a polar group stated in the aforementioned method (1); or (8) polymerizing an aromatic ring-containing alicyclic olefin not having a polar group, as the alicyclic olefin not having a polar group stated in the aforementioned method (2).

Examples of the aforementioned alicyclic olefin having a polar group include, but are not particularly limited to: alicyclic olefins having a carboxyl group, such as 5-hydroxycarbonylbicyclo[2.2.1]hept-2-ene, 5-methyl-5-hydroxycarbonylbicyclo[2.2.1]hept-2-ene, 5-carboxymethyl-5-hydroxycarbonylbicyclo[2.2.1]hept-2-ene, 9-hydroxycarbonyltetracyclo[6.2.1.1^{3,6}.0^{2,7}]dodeca-4-ene, 9-methyl-9-hydroxycarbonyltetracyclo[6.2.1.1^{3,6}.0^{2,7}]dodeca-4-ene, 9-carboxymethyl-9-hydroxycarbonyltetracyclo[6.2.1.1^{3,6}.0^{2,7}]dodeca-4-ene, 5-exo-6-endo-dihydroxycarbonylbicyclo[2.2.1]hept-2-ene, and 9-exo-10-endo-dihydroxycarbonyltetracyclo[6.2.1.1^{3,6}.0^{2,7}]dodeca-4-ene;

alicyclic olefins having a carboxylic acid anhydride group, such as bicyclo[2.2.1]hept-2-ene-5,6-dicarboxylic acid anhydride, tetracyclo[6.2.1.1^{3,6}.0^{2,7}]dodeca-4-ene-9,10-dicarboxylic acid anhydride, and hexacyclo[10.2.1.1^{3,10}.1^{5,8}.0^{2,11}.0^{4,9}]heptadeca-6-ene-13,14-dicarboxylic acid anhydride; alicyclic olefins having a carboxylic acid ester group, such as 9-methyl-9-methoxycarbonyltetracyclo[6.2.1.1^{3,6}.0^{2,7}]dodeca-4-ene, 5-methoxycarbonyl-bicyclo[2.2.1]hept-2-ene, and 5-methyl-5-methoxycarbonyl-bicyclo[2.2.1]hept-2-ene; alicyclic olefins having a phenolic hydroxyl group, such as (5-(4-hydroxyphenyl)bicyclo[2.2.1]hept-2-ene, 9-(4-hydroxyphenyl)tetracyclo[6.2.1.1^{3,6}.0^{2,7}]dodeca-4-ene, and N-(4-hydroxyphenyl)bicyclo[2.2.1]hept-5-ene-2,3-dicarboximide; and alicyclic olefins having an epoxy group, such as 5-epoxyethyl-2-norbornene, and 9-epoxyethyltetracyclo[6.2.1.1^{3,6}.0^{2,7}]dodeca-4-ene. These olefins may be used alone or in combination of two or more.

Examples of the aforementioned alicyclic olefin not having a polar group include, but are not particularly limited to: bicyclo[2.2.1]hept-2-ene (common name: norbornene), 5-ethyl-bicyclo[2.2.1]hept-2-ene, 5-butyl-bicyclo[2.2.1]hept-2-ene, 5-ethylidene-bicyclo[2.2.1]hept-2-ene, 5-methylidene-bicyclo[2.2.1]hept-2-ene, 5-vinyl-bicyclo[2.2.1]hept-2-ene, tricyclo[5.2.1.0^{2,6}]deca-3,8-diene (common name: dicyclopentadiene), tetracyclo[6.2.1.1^{3,6}.0^{2,7}]dodeca-4-ene (common name: tetracyclododecene), 9-methyl-tetracyclo[6.2.1.1^{3,6}.0^{2,7}]dodeca-4-ene, 9-ethyl-tetracyclo[6.2.1.1^{3,6}.0^{2,7}]dodeca-4-ene, 9-methylidene-tetracyclo[6.2.1.1^{3,6}.0^{2,7}]dodeca-4-ene, 9-ethylidene-tetracyclo[6.2.1.1^{3,6}.0^{2,7}]dodeca-4-ene, 9-methoxycarbonyl-tetracyclo[6.2.1.1^{3,6}.0^{2,7}]dodeca-4-ene, 9-vinyl-tetracyclo[6.2.1.1^{3,6}.0^{2,7}]dodeca-4-ene, 9-propenyl-tetracyclo[6.2.1.1^{3,6}.0^{2,7}]dodeca-4-ene, 9-phenyl-tetracyclo[6.2.1.1^{3,6}.0^{2,7}]dodeca-4-ene, tetracyclo[9.2.1.0^{2,10}.0^{3,8}]tetradeca-3,5,7,12-tetraene, cyclopentene, and cyclopentadiene. These olefins may be used alone or in combination of two or more.

Examples of the aforementioned aromatic olefin not having a polar group include, but are not particularly limited to, styrene, α-methyl styrene, and divinylbenzene. Note that any of these specific examples can be an aromatic olefin having a polar group, when it has the aforementioned polar group. These olefins may be used alone or in combination of two or more.

Examples of the aforementioned aromatic ring-containing alicyclic olefin having a polar group include, but are not particularly limited to, an alicyclic olefin having a phenolic hydroxyl group, 1,4-methano-1,4,4a,9a-tetrahydrodibenzofuran, 1,4-methano-1,4,4a,9a-tetrahydrodibenzothiazine, 1,4-methano-1,4,4a,9a-tetrahydrocarbazole, 1,4-methano-9-phenyl-1,4,4a,9a-tetrahydrocarbazole, 4-carboxyphenylbicyclo[2.2.1]hept-5-ene, and N-(4-carboxyphenyl)bicyclo[2.2.1]hept-5-ene-2,3-dicarboximide.

Examples of the aforementioned aromatic ring-containing alicyclic olefin not having a polar group include, but are not particularly limited to, 9-phenyl-tetracyclo[6.2.1.1^{3,6}.0^{2,7}]dodeca-4-ene, 5-(4-methylphenyl-2-norbornene, 5-(1-naphthyl)-2-norbornene, tetracyclo[9.2.1.0^{2,10}.0^{3,8}]tetradeca-3,5,7,12-tetraene (MTF), and 1,4-methano-1,4,4a,4b,5,8,8a,9a-octahydrofluorene.

Examples of the aforementioned monomer having a polar group include, but are not particularly limited to, ethylenically unsaturated compounds having a polar group. Examples of ethylenically unsaturated compounds having a polar group include: unsaturated carboxylic acid compounds, such as acrylic acid, methacrylic acid, α-ethylacrylic acid, 2-hydroxyethyl (meth)acrylic acid, maleic acid, fumaric acid, and itaconic acid; and unsaturated carboxylic acid anhydrides, such as maleic anhydride, butenyl succinic anhydride, tetrahydrophthalic anhydride, and citraconic anhydride. These compounds may be used alone or in combination of two or more.

Examples of monomers not having a polar group include ethylenically unsaturated compounds not having a polar group. Examples of ethylenically unsaturated compounds not having a polar group include: ethylene or α-olefins having 2 to 20 carbon atoms, such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, and 1-eicosene; and non-conjugated dienes, such as 1,4-hexadiene, 4-methyl-1,4-hexadiene, 5-methyl-1,4-hexadiene, and 1,7-octadiene. These compounds may be used alone or in combination of two or more.

Although not particularly limited, the weight-average molecular weight of the alicyclic olefin polymer (A1) disclosed herein is preferably 500 or more, more preferably 1,000 or more, and particularly preferably 3,000 or more from the perspective of the mechanical strength of the cured product formed by curing the curable resin composition, and is preferably 1,000,000 or less, more preferably 500,000 or less, and particularly preferably 300,000 or less from the perspective of the workability of molding a curable resin composition into a sheet- or film-like form. As used herein, a “weight-average molecular weight” refers to a weight-average molecular weight, in terms of polystyrene, that is measured by gel permeation chromatography using tetrahydrofuran as a solvent.

As the polymerization catalyst used to obtain the alicyclic olefin polymer (A1) disclosed herein by ring-opening polymerization, it is possible to use, for example, the conventionally well-known metathesis polymerization catalyst as described in WO2012/090980A1, which is incorporated herein by reference. Examples of metathesis polymerization catalysts include transition metal compounds containing atoms such as Mo, W, Nb, Ta, and Ru; among these, preferred are compounds containing Mo, W, or Ru, in view of high polymerization activity. Specific examples of particularly preferred metathesis polymerization catalysts may include: <1> a catalyst having any of a halogen group, an imide group, an alkoxy group, an allyloxy group, or a carbonyl group as a ligand, a molybdenum or tungsten compound as a primary catalyst, and an organometallic compound as a secondary component; and <2> a metal carbene complex catalyst containing Ru as a central metal. The polymerization of the alicyclic olefin polymer (A) is not particularly limited, and may be performed by using, for example, the method described in WO2012/090980A1, which is incorporated herein by reference.

Here, examples of the method of controlling the molecular weight of the alicyclic olefin polymer (A1) include a method that involves adding a vinyl or diene compound in appropriate amounts. The vinyl compound used for molecular weight adjustment is not particularly limited as long as it is an organic compound having a vinyl group, and examples thereof include those compounds as described in WO2012/090980A1, which is incorporated herein by reference. The amount of the vinyl or diene compound to be added may be selected arbitrarily, from 0.1 mol % to 10 mol % based on the monomers used for the polymerization, depending on the intended molecular weight.

As the polymerization catalyst used to obtain the alicyclic olefin polymer (A1) disclosed herein by addition polymerization, for example, the catalyst made of a titanium, zirconium, or vanadium compound and an organoaluminum compound as described in WO2012/090980A1, which is incorporated herein by reference, is suitably used. These polymerization catalysts may be used alone or in combination of two or more.

When a hydrogenated product of a ring-opened polymer is used as the alicyclic olefin polymer (A1) disclosed herein, hydrogenation of the ring-opened polymer is normally performed by using a hydrogenation catalyst. The hydrogenation catalyst is not particularly limited, and any hydrogenation catalyst that is commonly used for hydrogenation of an olefin compound may be adopted as appropriate. As the hydrogenation catalyst, it is possible to use, for example, the well-known catalyst as described in WO2012/090980A1, which is incorporated herein by reference.

The hydrogenation reaction is normally conducted in an organic solvent. Such an organic solvent may be selected as appropriate for the solubility of the resulting hydrogenated product. It is possible to use an organic solvent similar to that used for the aforementioned polymerization reaction. Thus, after the polymerization reaction, it is also possible to directly add a hydrogenation catalyst and cause a reaction without replacing the organic solvent. Further, among the aforementioned organic solvents used in the polymerization reaction, from the perspective of no reaction during the hydrogenation reaction, aromatic hydrocarbon solvents, aliphatic hydrocarbon solvents, ether solvents, and aromatic ether solvents are preferable; among these, more preferred are aromatic ether solvents.

Note that hydrogenation reaction conditions may be selected as appropriate depending on the type of the hydrogenation catalyst used, and it is possible to use, for example, the conditions as described in WO2012/090980A1, which is incorporated herein by reference.

The alicyclic olefin polymer (A) disclosed herein may be used as a polymer solution after the polymerization or hydrogenation reaction, or used after removing the solvent. The former is more preferable because it allows an additive to be well dissolved and dispersed when preparing a curable resin composition, and may simplify the process.

<Phosphorus-Containing Epoxy Compound (A2) Having the Structure Represented by Formula (1) or (2)>

The phosphorus-containing epoxy compound (A2) disclosed herein is a compound having, per molecule, at least one structure represented by formula (1) or (2) below and at least one epoxy (oxirane) structure.

Formulas (1) and (2)

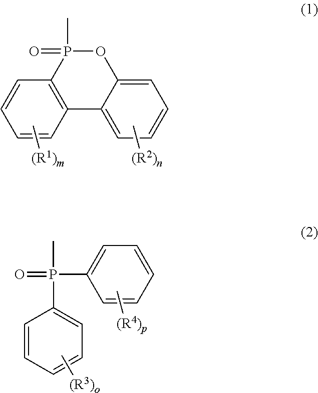

Where in the formula (1), R¹ and R² each independently represent a hydrocarbon group having 1 to 6 carbon atoms, m and n each independently represent an integer of 0 to 4, R¹s may be the same or different when m is 2 or more, and R²s may be the same or different when n is 2 or more, and

where in the formula (2), R³ and R⁴ each independently represent a hydrocarbon group having 1 to 6 carbon atoms, o and p each independently represent an integer of 0 to 5, R^{a}s may be the same or different when o is 2 or more, and R⁴s may be the same or different when p is 2 or more.

By blending the phosphorus-containing epoxy compound (A2) into our curable resin composition, the cured product obtained on the basis of the reaction between the epoxy structure of the phosphorus-containing epoxy compound (A2) and the polar group of the polar group-containing alicyclic olefin polymer (A1) may exhibit excellent flame retardancy and heat resistance.

The phosphorus-containing epoxy compound (A2) disclosed herein preferably has the structure represented by the formula (1) above (a phosphaphenanthrene structure), and more preferably has a structure represented by formula (3) below, where m=0 and n=0 in the formula (1).

Formula (3)

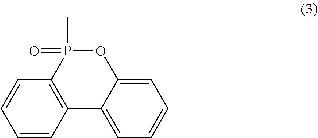 [SMILES: CP1(=O)Oc2ccccc2-c2ccccc21]

Examples of the epoxy (oxirane) structure of the phosphorus-containing epoxy compound (A2) include, but are not particularly limited to, a glycidyl ether structure, a glycidyl amine structure, a glycidyl ester structure, and an alicyclic epoxy structure.

Examples of the phosphorus-containing epoxy compound (A2) having the structure represented by formula (1) include, but are not particularly limited to: monovalent epoxy compounds such as 10-(glycidyloxypropyl)-9,10-dihydro-9-oxa-phosphaphenanthrene-10-oxide, and 10-[2-(3,4-epoxycyclohexyl)ethyl]-9,10-dihydro-9-oxa-10-phosphaphenanthr ene-10-oxide; and polyvalent epoxy compounds such as biphenyl-type epoxy compounds having a phosphaphenanthrene structure, bisphenol-type epoxy compounds having a phosphaphenanthrene structure, and phenolic novolac-type epoxy compounds having a phosphaphenanthrene structure.

Examples of the phosphorus-containing epoxy compound (A2) having the structure represented by the formula (1) include those epoxy compounds that have a variety of phosphaphenanthrene structures and that are obtained by modifying, by well-known methods, epoxy compounds with 9,10-dihydro-9-oxa-10-phosphaphenanthrene-10-oxide or derivatives thereof. Here, exemplary modification methods are described in, for example, JP1999166035A, JP1999279258A, JP2009185087A, and JP2010018765A, which are all incorporated herein by reference.

When a bisphenol-type epoxy resin, such as a bisphenol A-type epoxy resin and a bisphenol F-type epoxy resin, is used as the epoxy compound used for the aforementioned modification, a bisphenol-type epoxy compound having a phosphaphenanthrene structure is obtained. Also, when a phenolic novolac-type epoxy compound is used as the epoxy compound used for the aforementioned modification, a phenolic novolac-type epoxy compound having a phosphaphenanthrene structure is obtained.

Additionally, more specific examples of the phosphorus-containing epoxy compound (A2) having the structure represented by the formula (1) include epoxy compounds having a phosphaphenanthrene structure, such as FX-289BEK75 and FX-305EK70 (both manufactured by Nippon Steel & Sumikin Chemical Co., Ltd.).

Examples of the phosphorus-containing epoxy compound (A2) having the structure represented by the formula (2) include, but are not particularly limited to: monovalent epoxy compounds such as 3-glycidyloxy diphenylphosphine oxide, 3-glycidyloxypropyl diphenylphosphine oxide, 2-(3,4-epoxycyclohexyl)ethyl diphenylphosphine oxide; and polyvalent epoxy compounds such as biphenyl-type epoxy compounds having a diphenylphosphine oxide structure, bisphenol-type epoxy compounds having a diphenyl phosphine oxide structure, and phenolic novolac-type epoxy compounds having a diphenyl phosphine oxide structure.

As the phosphorus-containing epoxy compound (A2) disclosed herein, any phosphorus-containing epoxy compound may be used as long as it has at least one epoxy structure (epoxy group) in its molecule. In this disclosure, however, a polyvalent epoxy compound having at least two epoxy structures (epoxy groups) in its molecule is preferred from the perspective of its contribution to higher mechanical strength, improved flame retardancy, smaller linear expansion coefficient, and improved electrical properties of the resulting cured product. The reason is that the crosslink density may be improved by crosslinking of two or more epoxy structures (epoxy groups) in the phosphorus-containing epoxy compound (A2) with polar groups of the polar group-containing alicyclic olefin polymer (A1).

The content of the phosphorus-containing epoxy compound (A2) in our curable resin composition is, per 100 parts by mass of the alicyclic olefin polymer (A1), preferably 50 parts by mass or more, and more preferably 60 parts by mass or more, and preferably 90 parts by mass or less, more preferably 85 parts by mass or less, even more preferably 80 parts by mass or less, and particularly preferably 65 parts by mass or less. By blending 50 parts by mass or more of the phosphorus-containing epoxy compound (A2) per 100 parts by mass of the alicyclic olefin polymer (A1), the resulting cured product may exhibit sufficiently high flame retardancy. In addition, by blending 90 parts by mass or less of the phosphorus-containing epoxy compound (A2) per 100 parts by mass of the alicyclic olefin polymer (A1), it is possible to highly balance the electrical properties of the cured product and the peel strength of a plating layer, which is provided on a surface of the cured product, between the plating layer and the cured product. Further, by blending 80 parts by mass or less of the phosphorus-containing epoxy compound (A2) per 100 parts by mass of the alicyclic olefin polymer (A1), the resulting cured product may have good surface roughness.

In our curable resin composition, the ratio of epoxy groups derived from the phosphorus-containing epoxy compound (A2) to polar groups derived from the alicyclic olefin polymer (A1) (i.e., groups (epoxy-reactive groups) being reactive with the epoxy groups of the phosphorus-containing epoxy compound (A2)) is, as expressed by the equivalent ratio of “epoxy groups/epoxy-reactive groups (polar groups),” preferably 0.8 or more from the perspective of flame retardancy of the resulting cured product, and preferably 1.2 or less from the perspective of surface roughness of the resulting cured product. When the ratio of “epoxy groups/epoxy-reactive groups (polar groups)” is 0.8 or more, the resulting cured product may have sufficiently high flame retardancy, and when the ratio is 1.2 or less, the resulting cured product may have reasonably large surface roughness.

In our curable resin composition, the phosphorus content is preferably 0.8 mass % to 5 mass %, and more preferably 1 mass % to 2.5 mass %. When the phosphorus content is within the aforementioned range, the resulting cured product may exhibit excellent flame retardancy as well as excellent electrical properties. As used herein, for our curable resin composition, the term “phosphorus content” refers to a value (mass %) that is expressed as the mass of phosphorus atoms in the curable resin composition divided by the mass calculated by subtracting the mass of the filler from the mass of solids in the curable resin composition.

In addition, in our curable resin composition, the mass of phosphorus atoms relative to the mass of the alicyclic olefin polymer (A1) (which may be hereinafter abbreviated as “the mass of phosphorus atoms/the mass of COP,” as deemed appropriate) is preferably 1 mass % to 5 mass %, and more preferably 1.6 mass % to 3 mass %. When the mass of phosphorus atoms/the mass of COP is within the aforementioned range, the resulting cured product may exhibit excellent flame retardancy as well as excellent electrical properties.

<Filler (A3)>

Although the disclosed filler (A3) is not particularly limited and any inorganic or organic fillers that are commonly used in the industry may be used, inorganic fillers are preferred. By blending the filler (A3) disclosed herein into the curable resin composition, the cured product obtained from the composition may be excellent in low linear expansion properties and exhibit improved flame retardancy. Note that as the ratio that the filler (A3) occupies in the curable resin composition increases, the ratio of the resin in the curable resin composition decreases, with the result that the flame retardancy of the curable resin composition may be further improved accordingly.

Examples of inorganic fillers include, but are not particularly limited to, calcium carbonate, magnesium carbonate, barium carbonate, zinc oxide, titanium oxide, magnesium oxide, magnesium silicate, calcium silicate, zirconium silicate, hydrated alumina, magnesium hydroxide, aluminum hydroxide, barium sulfate, silica, talc, and clay. Among these, preferred are those not decomposed or dissolved in the presence of an oxidizing compound, such as an aqueous solution of permanganate, which is used for surface roughening treatment of the cured product, and particularly preferred is silica, because it provides fine particles more easily. From the perspective of dispersibility of the filler in the composition and water resistance of the cured product, preferably, the inorganic filler is already subjected to surface treatment with a silane coupling agent having a functional group, such as an epoxy group, an amino group, an isocyanate group, and an imidazole group. Note that a filler containing phosphorus atoms or a filler without containing phosphorus atoms may be used as the filler (A3), yet usually used is a filler without containing phosphorus atoms (specifically, the aforementioned inorganic filler).

In addition, the filler (A3) is preferably non-conductive such that it does not deteriorate dielectric properties of an electrically insulating layer obtained by curing the resulting curable resin composition. Note that the filler (A3) is not particularly limited, and it is possible to use the inorganic filler having the shape and average particle size as described in, for example, WO2012/090980A1, which is incorporated herein by reference.

In our curable resin composition, the content of the filler (A3) is, per 100 parts by mass of the alicyclic olefin polymer (A1), preferably 15 parts by mass or more, and more preferably 30 parts by mass or more, and preferably 200 parts by mass or less, and more preferably 150 parts by mass or less. By blending 15 parts by mass or more of the filler (A3) per 100 parts by mass of the alicyclic olefin polymer (A1), the resulting cured product may exhibit improved heat resistance. In addition, by blending 200 parts by mass or less of the filler (A3) per 100 parts by mass of the alicyclic olefin polymer (A1), it is possible to have an appropriate surface roughness of the cured product, and to balance the electrical properties of the cured product and the peel strength of a plating layer, which is provided on a surface of the cured product, between the plating layer and the cured product.

<Other Components>

Optionally, our curable resin composition may also contain a curing accelerator. Examples of curing accelerators include, but are not particularly limited to, aliphatic polyamines, aromatic polyamines, secondary amines, tertiary amines, acid anhydrides, imidazole derivatives, organic acid hydrazides, dicyandiamides and its derivatives, and urea derivatives; among these, particularly preferred are, for example, imidazole derivatives as described in WO2012/090980A1, which is incorporated herein by reference.

To improve the flame retardancy when used as a cured product, our curable resin composition may be further blended with a flame retardant, such as, for example, a halogen-based flame retardant, an ester phosphate-based flame retardant, and a reactive phenol compound. The amount of a flame retardant, when blended into our curable resin composition, is, per 100 parts by mass of the alicyclic olefin polymer (A1), preferably 20 parts by mass or less, more preferably 10 parts by mass or less, and even more preferably 5 parts by weight or less. Note that the term “flame retardant,” as used herein, does not include the phosphorus-containing epoxy compound (A2) having the structure represented by formula (1) or (2).

Furthermore, our curable resin composition may be blended with optional components, such as flame retardant aids, heat resistance stabilizers, weathering stabilizers, antioxidants, ultraviolet absorbers (laser processability-improving agents), leveling agents, antistatic agents, slip agents, anti-blocking agents, anti-fogging agents, lubricants, dyes, natural oils, synthetic oils, waxes, emulsions, magnetic materials, dielectric adjusting agents, or toughness increasing agents. The mix proportions of these optional components may be selected as appropriate without departing from the object of this disclosure.

Production methods of our curable resin composition are not particularly limited and, therefore, the aforementioned components may be mixed together directly or while being dissolved or dispersed in an organic solvent, or alternatively a composition may be prepared with some of the aforementioned components dissolved or dispersed in an organic solvent, and then mixed with the remaining components.

Next, the following items (1-1) to (1-5) using the aforementioned curable resin composition will be described below.

(1-1) A molded product (a single-layer film) formed by molding the curable resin composition into a sheet- or film-like form
(1-2) A prepreg formed by impregnating a fibrous substrate with the curable resin composition
(1-3) A laminate formed by stacking the single-layer film of (1-1) or the prepreg of (1-2) on a substrate
(1-4) A cured product formed by curing the curable resin composition
(1-5) A composite having a conductor layer formed on a surface of the cured product of (1-4)

(1-1: Single-Layer Film)

Our curable resin composition as described above may be molded into a sheet- or film-like form to obtain a single-layer film.

In forming a single-layer film from our curable resin composition, it is preferred that our curable resin composition, optionally with an organic solvent added thereto, is applied, sprayed, or cast on a support and then dried thereon to form a single-layer film.

Examples of the support used in this case include, for example, the resin film and the metal foil as described in WO2012/090980A1, which is incorporated herein by reference.

Although not particularly limited, the thickness of the single-layer film is normally 1 μm to 150 μm, preferably 2 μm to 100 μm, and more preferably 5 μm to 80 μm, from the perspective of workability and the like.

Methods of applying our curable resin composition include dip coating, roll coating, curtain coating, die coating, slit coating, and gravure coating.

Here, the single-layer film preferably contains our curable resin composition in an uncured or semi-cured state. As used herein, the term “uncured” refers to a state where the phosphorus-containing epoxy compound (A2) is substantially entirely dissolved in a solvent capable of dissolving the phosphorus-containing epoxy compound (A2) when the single-layer film is immersed in the solvent. In addition, the term “semi-cured” indicates a state in which the composition is not completely cured, but is further curable by heating; preferably, either a state in which the phosphorus-containing epoxy compound (A2) is partially dissolved (specifically, dissolved by 7 mass % or more) when the single-layer film is immersed in a solvent capable of dissolving the phosphorus-containing epoxy compound (A2), or a state in which the volume of a molded product after being immersed in the solvent for 24 hours is 200% or more (in swelling ratio) that before the immersion.

In addition, the temperature at which our curable resin composition is optionally dried after being applied on a support is preferably in a range at which our curable resin composition is not cured, and is normally 20° C. to 300° C., and preferably 30° C. to 200° C. If the drying temperature is excessively high, the curing reaction proceeds too much, and the resulting single-layer film may not stay in an uncured or semi-cured state. Additionally, the drying time is normally 30 seconds to 1 hour, and preferably 1 minute to 30 minutes.

Further, the single-layer film thus obtained is used while still attached to the support or after stripped off from the support.

(1-2: Prepreg)

A fibrous substrate may be impregnated with our curable resin composition to form a sheet- or film-like, composite molded product (prepreg).

Examples of the fibrous substrate used in this case include organic fibers such as polyamide fibers, polyaramid fibers, and polyester fibers, or inorganic fibers such as glass fibers and carbon fibers. In addition, the forms of the fibrous substrate include, for example, a woven fabric form such as plain weave or twill weave, or a non-woven fabric form.

Although not particularly limited, the thickness of the prepreg formed by impregnating the fibrous substrate with the curable resin composition is normally 1 μm to 150 μm, preferably 2 μm to 100 μm, and more preferably 5 μm to 80 μm, from the perspective of workability and the like. Additionally, the amount of the fibrous substrate in the composite molded product is normally 20 mass % to 90 mass %, and preferably 30 mass % to 85 mass %.

Although not particularly limited, methods of impregnating a fibrous substrate with our curable resin composition include a method that involves adding an organic solvent to our curable resin composition for viscosity adjustment and the like, and immersing a fibrous substrate in the curable resin composition with the organic solvent added thereto, a method that involves applying or spraying the curable resin composition with the added organic solvent on a fibrous substrate, and the like. In the method of applying or spraying, it is possible to place a fibrous substrate on a support and then apply or spray the curable resin composition with the added organic solvent thereon. Note that as is the case with the aforementioned single-layer film, this prepreg preferably contains our curable resin composition in an uncured or semi-cured state. It should not noted here that our curable resin composition with which the fibrous substrate is impregnated may be dried in a similar manner to the aforementioned single-layer film.

(1-3: Laminate)

The single-layer film or prepreg formed with our curable resin composition may be stacked on a substrate to form a laminate. As this laminate, any laminate may be used as long as it is formed by stacking at least the aforementioned single-layer film or prepreg. For example, if a laminate is used for producing a multilayer circuit board, the laminate may be formed by using, as the substrate, the one having a conductor layer on a surface thereof, and stacking a single-layer film or a prepreg on the substrate. In this case, the single-layer film or prepreg stacked on the substrate may be cured to form an electrically insulating layer.

Here, the substrate having a conductor layer on a surface thereof has a conductor layer on a surface of an electrically insulating substrate. An electrically insulating substrate is formed by curing a curable resin composition containing well-known, electrically insulating materials (for example, an alicyclic olefin polymer, epoxy resin, maleimide resin, (meth)acrylic resin, diallyl phthalate resin, triazine resin, polyphenyl ether, glass, and so on). The conductor layer is not particularly limited, and may be a layer that contains wires formed of conductive material such as conductive metal, and that may further contain circuits. No particular limitation is placed on the configuration, thickness, and the like of the circuits and wires. Specific examples of the substrate having a conductor layer on a surface thereof may include printed circuit boards and silicon wafer substrates. The thickness of the substrate having a conductor layer on a surface thereof is normally 10 μm to 10 mm, preferably 20 μm to 5 mm, and more preferably 30 μm to 2 mm.

For the substrate having a conductor layer on a surface thereof, the surface of the conductor layer is preferably pretreated to improve adhesion to an electrically insulating layer. As the pretreatment method, any well-known technique may be used without particular limitations.

The aforementioned laminate may be produced normally by thermal pressure bonding a single-layer film or a prepreg formed with our curable resin composition on the substrate having a conductor layer on a surface thereof.

Examples of the method of thermal pressure bonding include a method that includes placing a supported, molded product (single-layer film) or composite molded product (prepreg) on top of, and so as to come into contact with the conductor layer of the aforementioned substrate, and subjecting them to thermal pressure bonding (lamination) using a press machine, such as a press laminator, a press, a vacuum laminator, a vacuum press, and a roll laminator. Heating under pressure allows the conductor layer at the surface of the substrate and the molded product or composite molded product to be bonded together with substantially no gaps at the interface between them. Note that the thermal pressure bonding may be performed under known conditions.

(1-4: Cured Product)

The aforementioned curable resin composition, single-layer film, prepreg, or the film or prepreg in the laminate may be subjected to curing treatment to produce a cured product. Curing treatment is normally performed by heating the aforementioned curable resin composition, single-layer film, prepreg, or the single-layer film or prepreg in the laminate. For example, when a cured product is produced using a laminate, curing may be performed concurrently with the aforementioned thermal pressure bonding operation. Note that in the case of producing a cured product using a laminate, the thermal pressure bonding operation may be performed under the conditions with which curing does not occur, i.e., at a relatively low temperature and for a short period of time, prior to curing.

Here, in the case of curing the aforementioned laminate for use in the production of a multilayer circuit board, two or more single-layer films or prepregs may be bonded in contact with each other and stacked on the conductor layer of the substrate, for the purposes of improving the flatness of the electrically insulating layer formed by curing a single-layer film or a prepreg stacked on the substrate, increasing the thickness of the electrically insulating layer, and the like.

The curing temperature is normally 30° C. to 400° C., preferably 70° C. to 300° C., and more preferably 100° C. to 200° C. In addition, the curing time is 0.1 hours to 5 hours, and preferably 0.5 hours to 3 hours. The heating method is not particularly limited and may use, for example, an electric oven and the like.

(1-5: Composite)

A conductor layer may be formed on a surface of the cured product formed by curing the aforementioned curable resin composition to obtain a composite. A metal plating or a metal foil may be used as such a conductor layer. Materials for a metal plating include gold, silver, copper, rhodium, palladium, nickel, tin, and the like, and examples of metal foils include those used as the support of the aforementioned single-layer film or prepreg. In this disclosure, the use of a metal plating for the conductor layer is more preferable from the perspective of the ability to provide finer wiring. In the following an example of the production method of our composite will be described with reference to the case where the composite is a multilayer circuit board using a metal plating as a conductor layer.

Firstly, with the use of a cured product, in which a single-layer film or prepreg formed with our curable resin composition is stacked on a substrate having a conductor layer formed on a surface of an electrically insulating substrate, and is cured to form an electrically insulating layer, a via hole or through hole is formed through the electrically insulating layer. The via hole is formed in a multilayer circuit board to connect conductor layers included in the multilayer circuit board. The via hole or through hole may be formed by, for example, a chemical process such as photolithography, or a physical process such as drilling, laser, and plasma etching.

Then, surface roughening treatment is performed to roughen the surface of the electrically insulating layer of the cured product. The surface roughening treatment is performed to increase adhesiveness to the conductor layer formed on the electrically insulating layer.

The electrically insulating layer has an average surface roughness Ra of preferably less than 0.3 μm, and more preferably less than 0.2 μm. Note that the lower limit of the average surface roughness Ra of the electrically insulating layer may be 0.05 μm or more. In addition, the ten-point average surface roughness Rzjis is preferably 0.3 μm or more and less than 6 μm, and more preferably 0.5 μm or more and 5 μm or less. As used herein, “Ra” refers to arithmetic average roughness as specified in JIS B0601-2001 and “ten-point average surface roughness Rzjis” refers to ten-point average surface roughness as shown in Appendix 1 of JIS B0601-2001.

Methods of surface roughening treatment include, but are not particularly limited to, causing the surface of the electrically insulating layer to contact an oxidizable compound. Examples of the oxidizable compound include well-known compounds having oxidizing ability, such as inorganic oxidizable compounds and organic oxidizable compounds. From the perspective of the ease with which the average surface roughness of the electrically insulating layer can be controlled, the use of inorganic oxidizable compounds and organic oxidizable compounds is particularly preferable. Examples of an inorganic oxidizable compound include permanganate, chromic anhydride, dichromate, chromate, persulfate, activated manganese dioxide, osmium tetroxide, hydrogen peroxide, and periodate salts. Examples of an organic oxidizing compound include dicumyl peroxide, octanoyl peroxide, m-chloroperbenzoic acid, peracetic acid, and ozone.

The method of performing surface roughening treatment on a surface of the electrically insulating layer using an inorganic oxidizable compound or an organic oxidizable compound is not particularly limited, and it is possible to use, for example, the method as described in WO20120/90980A1, which is incorporated herein by reference.

Then, the electrically insulating layer is subjected to surface roughening treatment, after which a conductor layer is formed on the surface of the electrically insulating layer and on the surface of the inner wall of the via hole or through hole.

Although not particularly limited, the method of forming a conductor layer is preferably performed using electroless plating from the perspective of the ability to form a conductor layer exhibiting excellent close adherence.

For example, when a conductor layer is formed with electroless plating, in general, catalytic nuclei of silver, palladium, zinc, cobalt, and the like are first applied onto the electrically insulating layer before a thin metal film is formed on the surface of the electrically insulating layer. The method of applying catalyst nuclei onto the electrically insulating layer is not particularly limited, and may include, for example, immersing a metal compound of silver, palladium, zinc, cobalt, and the like, or a salt or complex thereof, in a solution (which may optionally contain acid, alkali, a complexing agent, a reducing agent, or the like) that is dissolved, at a concentration of 0.001 mass % to 10 mass %, in water or in alcohol or an organic solvent such as chloroform, and then reducing the metals.

As the electroless plating solution used in electroless plating, any well-known autocatalytic electroless plating solution may be used, and no particular limitation is placed on the type of metals, the type of reducing agents, the type of complexing agents, the concentration of hydrogen ions, the concentration of dissolved oxygen, and the like contained in the plating solution.

After forming a thin metal film, it is possible to apply anticorrosive treatment by causing the surface of the substrate to contact an anticorrosive agent. In addition, after forming a thin metal film, the thin metal film may be heated to improve close adherence, and the like. Heating temperature is normally 50° C. to 350° C., and preferably 80° C. to 250° C. At this point, heating may be performed under pressurized conditions. Examples of pressurizing methods used in this case include, for example, a method using physical pressurizing means, such as a heat-press machine, a heat-press roller, and the like. The pressure applied is normally 0.1 MPa to 20 MPa, and preferably 0.5 MPa to 10 MPa. Within this range, a high close adherence between the thin metal film and the electrically insulating layer may be guaranteed.

A resist pattern for plating is formed on the thin metal film thus obtained, and the plating is further grown on the resist (thick plating) by wet plating such as electrolysis plating. Then, after removing the resist, the thin metal film is etched conforming to the pattern to form a conductor layer. Thus, the conductor layer formed by this method is normally composed of a patterned, thin metal film and the plating grown thereon.

Alternatively, when a metal foil, instead of a metal plating, is used as a conductor layer constituting a multilayer circuit board, such a multilayer circuit board may be produced according to the method shown below.

That is, as is the case with the aforementioned case, a laminate, which comprises an electrically insulating layer formed by curing a single-layer film or prepreg and a conductor layer made of a metal foil, is first prepared. Note that such a laminate comprising an electrically insulating layer formed from a single-layer film or prepreg and a conductor layer made of a metal foil may also be used for, e.g., a printed wiring board according to a well-known subtractive method.

Then, in the laminate thus prepared, a via hole or through hole is formed through the electrically insulating layer in the same manner as described above. Then, to remove the residual resin in the via hole or through hole formed, the laminate with the via hole or through hole formed therein is subjected to desmearing. Examples of the desmearing method include, but are not particularly limited to, a method of causing the laminate to contact a solution (desmear solution) of an oxidizing compound of permanganate and the like.

Then, after desmearing the laminate, a conductor layer is formed on the surface of the inner wall of a via hole or through hole. The method of forming a conductor layer is not particularly limited and may use either electroless plating or electrolysis plating. However, from the perspective of the ability to form a conductor layer having excellent close adherence, a conductor layer may be formed by electroless plating, as is the case with the method of forming a metal plating as the aforementioned conductor layer.

Then, after forming a conductor layer on the surface of the inner wall of the via hole or through hole, a resist pattern for plating is formed on the metal foil, and the plating is further grown on the resist (thick plating) by wet plating such as electrolysis plating. Then, after removing the resist, the metal foil is etched conforming to the pattern to form a conductor layer. Thus, the conductor layer formed by this method is normally composed of a patterned metal foil and the plating grown thereon.

The multi-layer circuit board thus obtained may be used as a substrate for producing an additional laminate, the aforementioned single-layer film or prepreg may be bonded to the substrate by thermal pressure bonding and cured to form an electrically insulating layer, and, furthermore, a conductor layer may be formed on the electrically insulating layer according to the aforementioned method. By repeating this cycle, further multi-layering may be achieved.

The present composite thus obtained (and the multilayer circuit board as an example of the present composite) comprises the electrically insulating layer (our cured product) that is made of our curable resin composition and exhibits excellent flame retardancy, heat resistance, and peel strength. The present composite (and the multi-layer multilayer circuit board as an example of the present composite) may be suitably used for a variety of applications.

Subsequently, the following items (2-1) to (2-5) using the aforementioned curable resin composition will be described below.

(2-1) An insulating film with multi-layer structure having a resin layer made of the curable resin composition
(2-2) A prepreg comprising a plateable layer made of the curable resin composition (plateable layer-use resin composition), an adhesive layer, and a fibrous substrate
(2-3) A laminate formed by stacking the insulating film of (2-1) or the prepreg of (2-2) on a substrate
(2-4) A cured product formed by curing the insulating film (2-1) or the prepreg (2-2)
(2-5) A composite having a conductor layer formed on the surface of the cured product of (2-4)

(2-1: Insulating Film)

Our insulating film is a film with multi-layer structure that has a resin layer 1 made of the aforementioned curable resin composition and a resin layer 2 made of another curable resin composition. Note that our insulating film may be a film with multi-layer structure having three or more layers, as long as it has at least the resin layer 1 and the resin layer 2. In addition, the formulation of the curable resin composition used for the resin layer 1 is different from that of the other curable resin composition used for the resin layer 2.
Further, the resin layer 1 is preferably a plateable layer that has a surface on which a conductor layer is formed when the insulating film is used on top of an inner substrate or the like, while the resin layer 2 is preferably an adhesive layer that is adhered to a surface of the substrate constituting the inner substrate or the like. In such a case, our curable resin composition is used as a plateable layer-use resin composition.
In the above case, our insulating film may be a film with two-layer structure that is formed by a plateable layer and an adhesive layer in direct contact with each other, or a film with multi-layer structure formed by three or more layers, including an optional additional layer between a plateable layer and an adhesive layer. In this respect, in forming an additional layer, it is also possible to form an adhesive layer itself with multi-layer configuration, in which case such configuration may be obtained by, for example, forming an adhesive layer with multi-layer structure including a resin composition layer and a fibrous material-containing layer (corresponding to the additional layer). The additional layer may be a layer formed by using a resin composition, may be a resin film, or may be a fibrous substrate layer, and is not particularly limited in material, shape, or the like.
Hereinafter, focusing on the context in which our insulating film is an insulating film having a plateable layer made of a plateable layer-use resin composition (our curable resin composition) and an adhesive layer-use resin composition (the other curable resin composition), the insulating film will be described below.

[Plateable Layer-Use Resin Composition]

As a plateable layer-use resin composition for forming our plateable layer, the aforementioned curable resin composition may be used.

[Adhesive Layer-Use Resin Composition]

Next, an adhesive layer-use resin composition for forming an adhesive layer of our insulating film will be described below. The formulation of the adhesive layer-use resin composition disclosed herein is not particularly limited, as long as the resulting adhesive layer can follow the surface shape of a substrate (for example, an inner substrate on which an insulating film is stacked) and can be bonded to the substrate. It is thus possible to use a formulation generally used for an insulating film. Additionally, as the adhesive layer-use resin composition, an adhesive layer-use resin composition that contains a thermoplastic resin (B1) and a filler (B2) may be suitably used. Note that the formulation of the adhesive layer-use resin composition is different from that of the plateable layer-use resin composition.

<Thermosetting Resin (B1)>

The thermosetting resin (B1) used in the adhesive layer-use resin composition is not particularly limited, as long as it shows thermosetting properties on its own or in combination with a curing agent (B3), which will be described later, and has electrically insulating properties. Examples of the thermosetting resin (B1) may include epoxy resins, maleimide triazine resins, (meth)acrylic resins, diallyl phthalate resins, alicyclic olefin polymers, aromatic polyether polymers, benzocyclobutene polymers, cyanate-ester resins, and polyimides. These thermosetting resins (B1) are used alone or in combination of two or more. As the thermosetting resin (B1), a resin containing an alicyclic structure and a resin containing a fluorene structure are preferred from the perspective of heat resistance, water resistance, and electrical properties. Further, preferred as the thermosetting resin (B1) is a resin containing an epoxy group (i.e., an epoxy resin), and more preferred is a resin having at least two epoxy groups, from the viewpoint of increasing the crosslink density for improved resin strength. As used herein, the term “(meth)acrylic” means either “methacrylic” or “acrylic.”

Firstly, a resin that can be used as the thermosetting resin (B1) and contains an alicyclic structure will be described below. Examples of a resin containing an alicyclic structure include alicyclic olefin polymers. Additionally, examples of an alicyclic structure include those similar to the alicyclic structure of the aforementioned alicyclic olefin polymer (A1). The alicyclic olefin polymer may or may not have a polar group, yet preferably has a polar group. Examples of the polar group include a hydroxyl group, a carboxyl group, an alkoxyl group, an epoxy group, a glycidyl group, an oxycarbonyl group, a carbonyl group, an amino group, an ester group, and a carboxylic acid anhydride group; among these, particularly preferred is an epoxy group. Although not particularly limited, the content of those repeating units having a polar group is normally 5 mol % to 60 mol %, and preferably 10 mol % to 50 mol %, based on 100 mol % of the total repeating units constituting the alicyclic olefin polymer. Normally, the number of polar groups present in each repeating unit is preferably, but not particularly limited to, 1 to 2.

Examples of the production method of the alicyclic olefin polymer include a method that involves performing addition polymerization or ring-opening polymerization of an alicyclic olefin monomer and optional hydrogenation of an unsaturated bond, and a method that involves performing addition polymerization of an aromatic olefin monomer and hydrogenation of an aromatic ring of the resulting polymer.

In particular, a polar group-containing alicyclic olefin polymer that is preferred as the thermosetting resin (B1) may be prepared in a similar manner to the polar group-containing alicyclic olefin polymer (A1) contained in the aforementioned plateable layer.

As the resin containing an alicyclic structure that can be used as the thermosetting resin (B1), an alicyclic olefin polymer containing at least two epoxy groups is particularly preferred. Examples of an alicyclic olefin polymer containing at least two epoxy groups include epoxy resins having a dicyclopentadiene skeleton, such as: “EPICLON® HP7200L,” “EPICLON HP7200,” “EPICLON HP7200H,” “EPICLON HP7200HH” (trade name, all manufactured by Dainippon Ink and Chemicals, Inc.); Tactix® 558″ (trade name, manufactured by Huntsman Advanced Materials Inc.); and “XD-1000-1L,” “XD-1000-2L” (trade name, all manufactured by Nippon Kayaku Co., Ltd.).

Next, a resin containing a fluorene structure that can be used as the thermosetting resin (B1) will be described below. As used herein, the term “containing a fluorene structure” means that the resin contains in the molecule a fluorene structure represented by the following formula (4) (i.e., a structure incorporated in the molecule through the substitution of one or more hydrogen atoms in fluorene).

Formula (4)

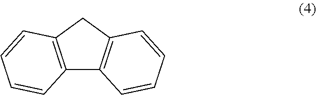 [SMILES: c1ccc2c(c1)Cc1ccccc1-2]

Examples of an epoxy resin containing a fluorene structure having at least two epoxy groups that is suitably used as the thermosetting resin (B1) include: “ONCOAT EX-1010,” “ONCOAT EX-1011,” “ONCOAT EX-1012,” “ONCOAT EX-1020,” “ONCOAT EX-1030,” “ONCOAT EX-1040,” “ONCOAT EX-1050,” “ONCOAT EX-1051” (trade name, all manufactured by Nagase & Co., Ltd.); and “OGSOL PG-100,” “OGSOL EG-200,” “OGSOL EG-250” (trade name, all manufactured by Osaka Gas Chemicals Co., Ltd.).

<Curing Agent (B3)>

In addition, the adhesive layer-use resin composition may optionally contain a curing agent (B3). As the curing agent (B3), any well-known curing agent may be selected and used as appropriate for the type of the thermosetting resin (B1) used, i.e., any curing agent containing a group reactive with the thermosetting resin (B1) may be used. Hereinafter, a preferred curing agent (B3) will be described with reference to the exemplary case where a resin containing an epoxy group (an epoxy resin) is used as the thermosetting resin (B1). The epoxy resin used herein is not particularly limited and may be any epoxy resin as long as it has an epoxy group, including alicyclic olefin polymers containing an epoxy resin.

The curing agent (B3) used for the epoxy resin is not particularly limited and may be any curing agent as long as it can cure the epoxy resin. Examples of the curing agent include alicyclic olefin polymers having a group reactive with an epoxy group, dicyandiamides, amine compounds, compounds synthesized from amine compounds, hydrazide compounds, melamine compounds, acid anhydrides, phenol compounds (phenol curing agents), active ester compounds, benzoxazine compounds, maleimide compounds, thermally-latent cationic polymerization catalysts, photo-latent cationic polymerization initiators, and cyanate resins. It is also possible to use a derivative of these curing agents. These curing agents may be used alone or in combination of two or more. Along with the curing agent, it is also possible to use a curing catalyst such as iron acetylacetonate. As the aforementioned amine compounds, compounds synthesized from amine compounds, hydrazide compounds, melamine compounds, and acid anhydrides, it is possible to use, for example, phthalic anhydrides, trimellitic anhydrides, pyromellitic anhydrides. As the aforementioned phenol compounds, it is possible to use, for example, those as described in WO2010/035451A1, which is incorporated herein by reference.

As the curing agent (B3) used for these epoxy resins, an alicyclic olefin polymer having a group reactive with an epoxy group, as well as an active ester compound are preferred from the perspective of electrical properties and water resistance.

Preferred examples of “a group reactive with an epoxy group” in the aforementioned alicyclic olefin polymer having a group reactive with an epoxy group include polar groups such as an acid anhydride group; among these, particularly preferred is an acid anhydride group. An alicyclic olefin polymer having a group reactive with an epoxy group may be prepared in a similar manner to the polar group-containing alicyclic olefin polymer (A1) contained in the aforementioned plateable layer.

Further, although the aforementioned active ester compound is not particularly limited as long as it has an active ester group, a preferred compound has at least two ester groups in the molecule. As the active ester compound, from the perspective of heat resistance and the like, preferred is an active ester compound obtained by reacting a carboxylic acid compound and/or a thiocarboxylic acid compound with a hydroxy compound and/or a thiol compound, more preferred is an active ester compound obtained by reacting a carboxylic acid compound with one or more selected from the group consisting of phenol compounds, naphthol compounds, and thiol compounds, and particularly preferred is an aromatic compound obtained by reacting a carboxylic acid compound with an aromatic compound having a phenolic hydroxyl group, and having at least two active ester groups in the molecule. The active ester compound may be linear or multi-branched. Considering an active ester compound derived from a compound having at least two carboxylic acids in the molecule, such a compound having at least two carboxylic acids in the molecule may, when containing an aliphatic chain, increase the compatibility with the epoxy resin and, when having an aromatic ring, increase the heat resistance of the resulting cured product.

As the carboxylic acid compound, phenol compound, naphthol compound, and thiol compound for forming an active ester compound, it is possible to use those described in JP2012153885A, which is incorporated herein by reference.

Here, as the active ester compound, for example, the aromatic compounds having an active ester group as described in JP200212650A, which is incorporated herein by reference, the multi-functional polyesters as described in JP2004277460A, which is incorporated herein by reference, or commercially available products may be used. Commercially available active ester compounds include, for example, “EXB9451,” “EXB9460,” “EXB9460S,” “EPICLON HPC-8000-65T” (trade name, all manufactured by DIC Corporation), “DC808” (trade name, manufactured by Mitsubishi Chemical Corporation), and “YLH1026” (trade name, manufactured by Mitsubishi Chemical Corporation).

The production method of an active ester compound is not particularly limited, and an active ester compound may be produced by a well-known method. For example, an active ester compound may be obtained by a condensation reaction of a carboxylic acid compound and/or a thiocarboxylic acid compound with a hydroxy compound and/or a thiol compound.

In this case, the mix proportion of the curing agent (B3) is, per 100 parts by mass of the epoxy resin, preferably 20 parts by mass to 120 parts by mass, more preferably 40 parts by mass to 100 parts by mass, and more preferably 50 parts by mass to 90 parts by mass. Further, considering an active ester compound used as the curing agent (B3), in an adhesive layer-use resin composition containing an epoxy resin, an active ester compound, and the like, the ratio of epoxy groups derived from the epoxy resin to active ester groups derived from the active ester compound is preferably from 0.5 to 1.25, more preferably from 0.7 to 1.1, and still more preferably 0.8 to 1.05, in terms of the equivalent ratio of “epoxy group/active ester group.” With a mix proportion of the active ester compound within the aforementioned range, it is possible to provide improved electrical properties and heat resistance to the cured product, and to keep the thermal expansion coefficient low.

<Filler (B2)>

As the filler (B2), it is possible to use a filler similar to the filler (A3) constituting the aforementioned plateable layer-use resin composition. The mix proportion of the filler (B2) disclosed herein is, per 100 parts by mass of the thermosetting resin (B1), preferably 50 parts by mass or more, and more preferably 60 parts by mass or more, and preferably 85 parts by mass or less, and more preferably 80 parts by mass or less. By blending the filler (B3) within the aforementioned range, it is possible to reduce the linear expansion coefficient of the resulting cured product, and improve its stackability.

<Other Components>

Furthermore, in addition to the aforementioned components, the adhesive layer-use resin composition disclosed herein may be blended, as is the case with the plateable layer-use resin composition (our curable resin composition), with optional components appropriately, such as curing accelerators, flame retardants, flame retardant aids, heat resistance stabilizers, weathering stabilizers, antioxidants, ultraviolet absorbers (laser processability-improving agents), leveling agents, antistatic agents, slip agents, anti-blocking agents, anti-fogging agents, lubricants, dyes, natural oils, synthetic oils, waxes, emulsions, magnetic materials, dielectric adjusting agents, and toughness increasing agents.

Production methods of the adhesive layer-use resin composition disclosed herein are not particularly limited. Therefore, the aforementioned components may be mixed together directly or while being dissolved or dispersed in an organic solvent, or alternatively a composition may be prepared with some of the aforementioned components dissolved or dispersed in an organic solvent, and then mixed with the remaining components.

[Production Method of Insulating Film]

Our insulating film with multi-layer structure may be produced by, for example, the following two methods: (1) one includes applying, spraying, or casting, and optionally drying the aforementioned plateable layer-use resin composition on a support to form a plateable layer, then further applying or casting, and optionally drying thereon the aforementioned adhesive layer-use resin composition to form an adhesive layer; and (2) the other includes stacking a plateable layer-use molded product that is obtained by applying, spraying, or casting, and optionally drying the aforementioned plateable layer-use resin composition on a support, and that is molded into a sheet- or film-like form, on an adhesive layer-use molded product that is obtained by applying, spraying, or casting, and optionally drying the aforementioned adhesive-layer resin composition on a support, and that is molded into a sheet- or film-like form, and integrating these molded products. Among these production methods, the aforementioned production method (1) is preferred, since it is easier to perform and more productive. Note that when an insulating film is produced with an optional additional layer between a plateable layer and an adhesive layer, for example, it is possible to use any of the following: a production method including, in the aforementioned production method (1), forming an additional layer on the plateable layer, and then forming an adhesive layer on the additional layer; or a production method including, in the aforementioned production method (2), integrating the plateable layer-use molded product with the adhesive layer-use molded product via a intermediate layer-use molded product.

The plateable layer-use resin composition or the adhesive layer-use resin composition, optionally with an organic solvent added thereto, is preferably applied, sprayed, or cast on the support, at the time of, in the aforementioned production method (1), applying, spraying, or casting the plateable layer-use resin composition on the support, and at the time of applying, spraying, or casting the adhesive layer-use resin composition on the applied, sprayed, or cast plateable layer-use resin composition, or alternatively, at the time of, in the aforementioned production method (2), molding the plateable layer-use resin composition and the adhesive layer-use resin composition into a sheet- or film-like form to obtain a plateable layer-use molded product and an adhesive layer-use molded product, respectively.

Examples of the support used in this case include, for example, the resin film and the metal foil as described in WO2012/090980A1, which is incorporated herein by reference.

Although no particular limitation is placed on the thickness of the plateable layer-use resin composition and of the adhesive layer-use resin composition in the aforementioned production method (1), or on the thickness of the plateable layer-use molded product and of the adhesive layer-use molded product in the aforementioned production method (2), the thickness of the plateable layer in the insulating film is preferably 1 μm to 10 μm, more preferably 1.5 μm to 8 μm, and even more preferably 2 μm to 5 μm.

When the thickness of the plateable layer is 1 μm or more, a conductive layer can be easily formed on the cured product obtained by curing the insulating film, and when the thickness is 10 μm or less, the linear expansion of the cured product can be reduced. In addition, the thickness of the adhesive layer is preferably 5 μm to 100 μm, more preferably 10 μm to 80 μm, and even more preferably 15 μm to 60 μm. For the thickness of the adhesive layer, a thickness of 5 μm or more is advantageous in that the insulating film exhibits good wire embeddability, and a thickness of 100 μm or less is advantageous in that the hole formability for drilling a hole to make the insulating film conductive in the vertical direction can improve, uniform plating can be formed on the surface of the hole, and so on.

Examples of the method of applying the plateable layer-use resin composition and the adhesive layer-use resin composition include those similar to the method of applying the curable resin composition stated in the section (1-1: Single-layer Film).

The temperature for drying the plateable layer-use resin composition, the adhesive layer-use resin composition, the plateable layer-use molded product, and the adhesive layer-use molded product is preferably in a range at which they are not cured, normally at 20° C. to 300° C., and preferably at 30° C. to 200° C. Additionally, the drying time is normally 30 seconds to 1 hour, and preferably 1 minute to 30 minutes.

Note that it is preferable for our insulating film to have a plateable layer and an adhesive layer, constituting the insulating film, in an uncured or semi-cured state, respectively. In particular, when the adhesive layer is in an uncured or semi-cured state, the adhesiveness of the adhesive layer may be further improved. Here, considering a composition containing the aforementioned thermosetting resin (B1) and the curing agent (B3) used as the resin components constituting the adhesive layer-use resin composition, an uncured state of the adhesive layer refers to a state in which the thermosetting resin (B1) and the curing agent (B3) in the adhesive layer are substantially entirely dissolved when the insulating film is immersed in a solvent capable of dissolving the thermosetting resin (B1) and alternatively in a solvent capable of dissolving the curing agent (B3), respectively. On the other hand, a semi-cured state of the adhesive layer refers to a state in which the composition is not completely cured, but is further curable by heating; preferably, either a state in which the thermosetting resin (B1), and alternatively the curing agent (B3), are partially dissolved (specifically, dissolved by 7 mass % or more, and such that they partly remain undissolved) when the insulating film is immersed in a solvent capable of dissolving the thermosetting resin (B1), and alternatively in a solvent capable of dissolving the curing agent (B3), respectively, or a state in which the volume of the adhesive layer part, after the insulating film is immersed for 24 hours in a solvent capable of dissolving the thermosetting resin (B1), and alternatively in a solvent capable of dissolving the curing agent (B3), is 200% or more (in swelling ratio) that before the immersion, respectively. Note that an uncured state and a semi-cured state of the plateable layer can be defined similarly to the above for an uncured state and a semi-cured state of the adhesive layer, by replacing the thermosetting resin (B1) with the polar group-containing alicyclic olefin polymer (A1), and the curing agent (B3) with the phosphorus-containing epoxy compound (A2), respectively.

(2-2: Prepreg)

Our prepreg comprising: a plateable layer made of a plateable layer-use resin composition containing a polar group-containing alicyclic olefin polymer (A1), a phosphorus-containing epoxy compound (A2) having the structure represented by the formula (1) or (2), and a filler (A3); an adhesive layer made of an adhesive layer-use resin composition; and a fibrous substrate. Here, the fibrous substrate is preferably positioned in the adhesive layer. Further, the fibrous substrate is more preferably arranged off to one side in the adhesive layer so as to be closer to the plateable layer.

Examples of the fibrous substrate and its form include those as stated in the section (1-2: Prepreg). The thickness of the fibrous substrate is preferably 5 μm or more, and more preferably 10 μm or more, from the perspective of facilitating its handling. In addition, for example, considering the case where a fibrous substrate is positioned in the adhesive layer, the fibrous substrate may be increased in thickness relative to the fibrous substrate and, from the perspective of the ability to improve wire embeddability to the adhesive layer, the thickness of the adhesive layer is preferably 100 μm or less, and more preferably 50 μm or less.

Although the production method of our prepreg is not particularly limited as long as the prepreg has an adhesive layer on one surface, a plateable layer on the other surface, and a fibrous substrate inside, for example, our prepreg may be produced by the following methods: (1) a method including stacking a supported, adhesive layer-use resin composition film and a supported, plateable layer-use resin composition film so as to sandwich a fibrous substrate between the resin composition layers of the respective films, optionally, for example, under pressed, vacuum, or heated conditions, to produce our prepreg; (2) a method including immersing, and optionally drying, one of an adhesive layer-use resin composition and a plateable layer-use resin composition in a fibrous substrate, and then applying, spraying, or casting the other resin composition on the surface, or stacking the other supported resin composition film on the surface thereof, to produce our prepreg; and (3) a method including stacking, by applying, spraying, or casting, one of an adhesive layer-use resin composition and a plateable layer-use resin composition on a support, placing a fibrous substrate on top of it, further stacking, by applying, spraying, or casting, and optionally drying, the other resin composition thereon to produce our prepreg. Note that each of these methods preferably control the workability of impregnating with the fibrous substrate and of applying, spraying, or casting on the support, by adjusting the viscosity of the composition optionally with an organic solvent added thereto.

In addition, examples of the support used in this case include, for example, the resin film and the metal foil as described in WO2012/090980A1, which is incorporated herein by reference. Such a support may be attached to both surfaces of the prepreg, not limited to one surface.

Although not particularly limited, the thickness of our prepreg is preferably set, for the same reasons as the aforementioned insulating film, such that the plateable layer has a thickness of preferably 1 μm to 10 μm, more preferably 1.5 μm to 8 μm, and more preferably 2 μm to 5 μm, and such that the adhesive layer has a thickness of preferably 5 μm to 100 μm, more preferably 10 μm to 80 μm, and even more preferably 15 μm to 60 μm.

Examples of the method of applying the plateable layer-use resin composition and the adhesive layer-use resin composition in producing our prepreg include dip coating, roll coating, curtain coating, die coating, slit coating, and gravure coating.

In addition, it is preferable for our prepreg to have the resin compositions, which constitute the plateable layer and the adhesive layer, respectively, in an uncured or semi-cured state, as is the case with our insulating film as described above.

(2-3: Laminate)

Our insulating film or prepreg as described above may be stacked on a substrate to form a laminate. As this laminate, any laminate may be used as long as it is formed by stacking at least our insulating film or prepreg as described above. For example, if a laminate is used for producing a multilayer circuit board, the laminate may be formed by using, as the substrate, one having a conductor layer on a surface thereof, and stacking our insulating film or prepreg as described above on the substrate. In this case, the film or prepreg stacked on the substrate may be cured to form an electrically insulating layer. At this point, our insulating film or prepreg is configured to be stacked on a substrate via the adhesive layer, and such that the plateable layer is located at a surface of the laminate. With the plateable layer made of a predetermined composition and the adhesive layer being stacked with the aforementioned positional relationship, it is possible to allow the conductor layer located at a surface of the substrate to be well embedded in the adhesive layer (i.e., to make the adhesive layer well conform to the shape of the conductor layer), and to form a surface of the electrically insulating layer by a cured product of the plateable layer, thereby achieving good plating on the electrically insulating layer.

Here, as the substrate having a conductor layer on a surface thereof, it is possible to use a substrate similar to the one stated in the section (1-3: Laminate).

Our laminate may be produced normally by thermal pressure bonding our insulating film or prepreg as described above on the substrate having a conductor layer on a surface thereof.

Examples of the method of thermal pressure bonding include a method that includes placing a supported insulating film or prepreg on top of, and so as to come into contact with the conductor layer of the aforementioned substrate, and subjecting them to thermal pressure bonding (lamination) using the press machine stated in the section (1-3: Laminate). Heating under pressure allows the conductor layer at the surface of the substrate and the insulating film to be bonded together with substantially no gaps at the interface between them. Note that the thermal pressure bonding may be performed under known conditions.

(2-4: Cured Product)

The aforementioned insulating film, prepreg, or the insulating film or prepreg in the laminate may be subjected to curing treatment to produce a cured product. Curing treatment is normally performed by heating the aforementioned insulating film, prepreg, or the insulating film or prepreg in the laminate. For example, when a cured product is produced using a laminate, curing may be performed concurrently with the aforementioned thermal pressure bonding operation. Note that in the case of producing a cured product using a laminate, the thermal pressure bonding operation may be performed under the conditions with which curing does not occur, i.e., at a relatively low temperature and for a short period of time, prior to curing.

Here, in the case of curing the aforementioned laminate for use in the production of a multilayer circuit board, for the purposes of improving the flatness of the electrically insulating layer formed by curing an insulating film or prepreg stacked on the substrate, increasing the thickness of the electrically insulating layer, and the like, at least two insulating films or prepregs disclosed herein may be bonded in contact with each other and stacked on the conductor layer of the substrate.

As the curing temperature, curing time, and heating method, conditions and a method similar to those described in the section (1-4: Cured Product) may be used.

(2-5: Composite)

A composite formed by using our insulating film or prepreg is obtained by forming a conductor layer on a surface of our cured product, specifically on a plateable layer in which the cured product has been cured. Metal plating may be used as such a conductor layer, and materials of metal plating include those stated in the section (1-5: Composite). Hereinafter, a production method of our composite will be described with reference to a multilayer circuit board as an example of our composite. In the multilayer circuit board, a cured product of our insulating film (or prepreg) forms an electrically insulating layer.

Firstly, with the use of a cured product, in which our insulating film or prepreg is stacked on a substrate having a conductor layer formed on a surface of an electrically insulating substrate, and is cured to form an electrically insulating layer, a via hole or through hole is formed through the electrically insulating layer. The via hole is formed in the multilayer circuit board to connect conductor layers included in the multilayer circuit board. The via hole or through hole may be formed by a process similar to that stated in the section (1-5: Composite).

Then, surface roughening treatment is performed to roughen the electrically insulating layer of the cured product, specifically the surface of the plateable layer of the cured insulating film or prepreg. The surface roughening treatment is performed to increase adhesiveness to the conductive layer formed on the electrically insulating layer.

The average surface roughness Ra and the ten-point average surface roughness Rzjis of the electrically insulating layer may be within ranges similar to those stated in the section (1-5: Composite), respectively.

The surface roughening treatment is not particularly limited and may be performed in a similar manner to that stated in the section (1-5: Composite).

Then, the electrically insulating layer is subjected to surface roughening treatment, after which a conductor layer is formed on the surface of the electrically insulating layer (i.e., the surface of the plateable layer of the cured product of the insulating film) and on the surface of the inner wall of the via hole or through hole.

Although not particularly limited, the method of forming a conductor layer is preferably performed using electroless plating from the perspective of the ability to form a conductor layer exhibiting excellent close adherence.

For example, when a conductor layer is formed with electroless plating, in general, catalyst nuclei of silver, palladium, zinc, cobalt, and the like are first applied onto the electrically insulating layer (more specifically, onto the cure product layer formed upon curing of the plateable layer of the insulating film or prepreg) before a metal thin film is formed on the surface of the electrically insulating layer. The method of applying catalytic nuclei onto the electrically insulating layer is not particularly limited and may be performed in a similar manner to that stated in the section (1-5: composite).

As the electroless plating solution used in electroless plating, any well-known autocatalytic electroless plating solution may be used, and no particular limitation is placed on the type of metals, the type of reducing agents, the type of complexing agents, the concentration of hydrogen ions, the concentration of dissolved oxygen, and the like in the plating solution.

After forming a thin metal film, it is possible to apply anticorrosive treatment by causing the surface of the substrate to contact an anticorrosive agent. In addition, after forming a thin metal film, the thin metal film may be heated to improve close adherence, and the like. Heating temperature may be in a range similar to that stated in the section (1-5: Composite). At this point, heating may be performed under pressurized conditions. The pressurizing method used in this case may be a method similar to that stated in the section (1-5: Composite), and the pressure to be applied may be in a range similar to that specified in the section (1-5: Composite).

A resist pattern is formed on the thin metal film thus formed, and the plating is further grown thereon (thick plating) by wet plating such as electrolysis plating. Then, after removing the resist, the thin metal film is etched conforming to the pattern to form a conductor layer. Thus, the conductor layer formed by this method is normally composed of a patterned, thin metal film and the plating grown thereon.

The composite thus obtained (and the multilayer circuit board as an example of the composite) has an electrically insulating layer formed by our insulating film (or prepreg), which layer is excellent in all of flame retardancy, heat resistance, and peel strength. The composite (and the multilayer circuit board as an example of the composite) may be suitably used for a variety of applications.

(Substrate for Electronic Material)

The cured product formed by curing our curable resin or the aforementioned composite may be used as a substrate for electronic material. Our substrate for electronic material comprising, as constituent materials, the cured product formed by curing the curable resin or the composite, may be suitably used for a variety of electronics, such as mobile phones, PHSs, notebook computers, PDAs (personal digital assistant), mobile videophones, personal computers, supercomputers, servers, routers, LCD projectors, engineering work stations (EWS), pagers, word processors, televisions, view-finder type or monitor-direct-view type video tape recorders, electronic organizers, electronic desk calculators, car navigation devices, POS terminals, and touch panel devices.

### EXAMPLES

Our products will now be described below based on examples. However, our products are not limited to the examples disclosed herein.

(i) Number-Average Molecular Weight (Mn), Weight-Average Molecular Weight (Mw), and Molecular Weight Distribution (Mw/Mn) of Alicyclic Olefin Polymer

The number-average molecular weight (Mn), the weight average molecular weight (Mw), and the molecular weight distribution (Mw/Mn) of an alicyclic olefin polymer were measured by gel permeation chromatography (GPC), using tetrahydrofuran as the developing solvent, and were determined in terms of polystyrene.

(ii) Hydrogenation Rate of Alicyclic Olefin Polymer

The ratio of the number of moles of unsaturated bonds after hydrogenation to the number of moles of unsaturated bonds in the polymer before hydrogenation was determined by ¹H-NMR spectroscopy at 400 MHz, and the result was defined as the hydrogenation rate.

(iii) Content of Monomer Units Having Polar Group in Alicyclic Olefin Polymer

The ratio of the number of moles of monomer units having a polar group (carboxylic anhydride group) to the number of moles of the total monomer units in the polymer was determined by ¹H-NMR spectroscopy at 400 MHz, and the result was defined as the content of monomer units having a polar group (carboxylic anhydride group) in the polymer.

(iv) Flame Retardancy

Supported films were prepared and stacked on both sides, from which copper had been etched off, of a halogen-free substrate of 0.6 mm thick×11 cm long×16 cm wide, and, after peeling off only the film support, the substrate was allowed to stand in an air atmosphere at 180° C. for 60 minutes so that the resin composition layers of the films were cured to form insulating films. The substrate with the insulating film formed thereon was cut into a strip of 13 mm wide and 100 mm long to prepare a substrate for flame retardancy evaluation. Measurement was performed on this strip in conformance with the UL-94 Vertical Flammability Test method, and the results were evaluated based on the following criteria.

A: UL 94 V-0

B: UL 94 V-1

C: below UL 94 V-1

(v) Heat Resistance

The obtained substrate was cut into 25 mm square pieces, which in turn were floated in a solder bath at 260° C. for 120 seconds and visually observed for a change in appearance to evaluate heat resistance based on the following criteria.

A: appearance unchanged

C: appearance changed

(vi) Close Adherence (Peel Strength) Between Electrically Insulating Layer and Conductor Layer

Measurement was conducted on the obtained substrate in conformance with JIS C6481-1996 to determine the peel strength between the conductor layer and the cured product of the laminate, and the results were evaluated based on the following criteria.

A: peel strength being 5N/cm or more

C: peel strength being lower than 5N/cm

(vii) Surface Roughness of Electrically Insulating Layer (Arithmetic Average Roughness Ra)

Measurement was conducted on the surface of an electrically insulating layer of a cured product formed by curing a laminate using a surface profiler (WYKO NT1100, manufactured by Veeco Instruments Inc.) to determine the surface roughness (arithmetic average roughness Ra) in the measuring range of 91 μm×120 μm, and the results were evaluated based on the following criteria.

A: arithmetic average roughness Ra being less than 0.2 μm

B: arithmetic average roughness Ra being 0.2 μm or more and less than 0.3 μm

C: arithmetic average roughness Ra being 0.3 μm or more

### Synthesis Example 1 of Alicyclic Olefin Polymer

As the first-stage polymerization, 35 molar parts of 5-ethylidene-bicyclo[2.2.1]hept-2-ene (EdNB), 0.9 molar parts of 1-hexene, 340 molar parts of anisole, and 0.005 molar parts of 4-acetoxybenzylidene(dichloro)(4,5-dibromo-1,3-dimesityl-4-imidazolin-2-yl idene)(tricyclohexylphosphine)ruthenium (C1063, manufactured by Wako Pure Chemical Industries, Ltd.) were charged into a pressure-resistant glass reactor purged with nitrogen, and subjected to polymerization reaction under stirring for 30 minutes at 80° C. to obtain a solution of a norbornene-based ring-opening polymer.
Then, as the second-stage polymerization, to the solution obtained in the first-stage polymerization were added 35 molar parts of tetracyclo[9.2.1.0^{2,10}.0^{3,8}]tetradeca-3,5,7,12-tetraene (MTF), 30 molar parts of bicyclo[2.2.1]hept-2-ene-5,6-dicarboxylic acid anhydride (NDCA), 250 molar parts of anisole, and 0.01 molar parts of C1063, and the mixture was subjected to polymerization reaction under stirring for 1.5 hours at 80° C. to obtain a solution of a norbornene-based ring-opening polymer. Gas chromatography measurement of this solution showed that the solution contained substantially no residual monomer and the polymerization conversion rate was 99% or more.
Then, a solution of the ring-opening polymer thus obtained was charged into an autoclave equipped with a stirrer which had been purged with nitrogen, 0.03 molar parts of C1063 was added, and the mixture was subjected to hydrogenation reaction by being stirred for 5 hours at 150° C. with a hydrogen pressure of 7 MPa to obtain a solution of an alicyclic olefin polymer (P-1), which was a hydrogenated product of the norbornene-based ring-opening polymer. The obtained polymer (P-1) had a weight-average molecular weight of 60,000, a number average molecular weight of 30,000, and a molecular weight distribution of 2. In addition, the hydrogenation rate was 95%, and the content of monomer units having a carboxylic acid anhydride group was 30 mol %. The solid concentration of the solution of the polymer (P-1) was 20 mass %.

### Synthesis Example 2 of Alicyclic Olefin Polymer

To a pressure-resistant glass reactor purged with nitrogen charged were 70 molar parts of tetracyclo[9.2.1.0^{2,10}.0^{3,8}]tetradeca-3,5,7,12-tetraene (MTF), 30 molar parts of bicyclo[2.2.1]hept-2-ene-5,6-dicarboxylic acid anhydride (NDCA), 0.9 molar parts of 1-hexene, 590 molar parts of anisole, and 0.015 molar parts of C1063, which in turn were subjected to polymerization reaction under stirring for 1 hour at 80° C. to obtain a solution of a norbornene-based ring-opening polymer. Gas chromatography measurement of this solution showed that the solution contained substantially no residual monomer and the polymerization conversion rate was 99% or more.
Then, a solution of the ring-opening polymer thus obtained was charged into an autoclave equipped with a stirrer which had been purged with nitrogen, and subjected to hydrogenation reaction by being stirred for 5 hours at 150° C. with a hydrogen pressure of 7 MPa to obtain a solution of an alicyclic olefin polymer (P-2), which was a hydrogenated product of the norbornene-based ring-opening polymer. The obtained polymer (P-2) had a weight-average molecular weight of 50,000, a number average molecular weight of 26,000, and a molecular weight distribution of 1.9. In addition, the hydrogenation rate was 97%, and the content of monomer units having a carboxylic acid anhydride group was 30 mol %. The solid concentration of the solution of the polymer (P-2) was 20 mass %.

Firstly, single-layer films, laminates, cured products of the laminates, and substrates were prepared using curable resin compositions and evaluated as described below.

### Example 1

### Preparation of Curable Resin Composition

In this case, 454.5 parts by mass of a solution of the alicyclic olefin polymer (P-1) obtained in Synthesis Example 1 (100 parts by mass in solid content of the polymer (P-1)), 72 parts by mass of a solution of a phosphorus-containing epoxy compound (an epoxy compound having a phosphaphenanthrene structure, FX305EK70, manufactured by Nippon Steel & Sumikin Chemical Co., Ltd., 70% methyl ethyl ketone solution, phosphorus content 2%, epoxy equivalent 485 g/eq) (50.4 parts by mass in solid content of the epoxy compound), 40 parts by mass of untreated spherical silica (Admafine® SO-C1, manufactured by Admatechs Company Limited, volume average particle size 0.25 μm) as an inorganic filler, 1 part by mass of 2-[2-hydroxy-3,5-bis(α,α-dimethylbenzyl)phenyl]-2H-benzotriazole as a laser processability-improving agent, 1 part by mass of tris-(3,5-di-t-butyl-4-hydroxybenzyl)-isocyanurate (IRGANOX®) 3114, manufactured by BASF SE) as an antioxidant, and 0.5 parts by mass of tetrakis(1,2,2,6,6-pentamethyl-4-piperidyl)1,2,3,4-butanetetracarboxylate (ADEKA STAB® LA52, manufactured by ADEKA Corporation) as an antioxidant, were mixed and dispersed in a high-pressure homogenizer.
With this further mixed was 1 part by mass of a 50% solution of 1-benzyl-2-phenylimidazole in anisole as a curing accelerator, and the mixture was stirred with a stirrer for 5 minutes to obtain a varnish of the curable resin composition.

(Preparation of Supported Single-Layer Film)

The varnish of the curable resin composition obtained in the above process was applied on a polyethylene terephthalate film (support) of 100 μm thick using a doctor blade and an automatic film applicator (both manufactured by Tester Sangyo Co., Ltd.), and then dried in a nitrogen atmosphere at 80° C. for 5 minutes to yield a supported single-layer film on which a 30 μm-thick resin composition layer made of the resin composition in an uncured state was formed. Measurement was conducted on the resulting supported single-layer film to determine the flame retardancy according to the aforementioned method. The results are presented in Table 1.

(Preparation of Laminate)

Then, separately from the above, a double-sided copper-clad laminate (an inner substrate) of 0.6 mm thick×125 mm long×125 mm wide was prepared with 18 μm-thick copper being adhered on the surfaces of the core material obtained by impregnating a glass fiber with a varnish containing a glass filler and a halogen-free epoxy resin, and with the copper surfaces being micro-etched by contact with an organic acid.

The supported single-layer film obtained in the above process was cut into 125 mm square pieces, which in turn were bonded to both surfaces of the inner substrate, with respective surfaces on the resin composition layer side facing inward, and then subjected to primary press. The primary press is such thermal pressure bonding that is performed in a vacuum laminator equipped with heat-resistant rubber press plates on its bottom and top, under a reduced pressure of 200 Pa, at a temperature of 110° C., a pressure of 0.1 MPa, for a duration of 90 seconds.

Furthermore, an oil hydraulic press machine equipped with metallic press plates on its bottom and top was used to perform thermal pressure bonding at a pressure bonding temperature of 110° C., a pressure of 1 MPa, for a duration of 90 seconds. Then, the support was peeled off to yield a laminate of the resin composition layer made of the curable resin composition and the inner substrate. Further, the laminate was allowed to stand in an air atmosphere at 180° C. for 60 minutes, causing the resin composition layer to be cured to form an electrical insulating layer on the inner substrate.

(Swelling Treatment Step)

The resulting cured product was immersed under shaking for 15 minutes in an aqueous solution at 60° C., which had been prepared to contain 500 mL/L of a swelling liquid (“Swelling Dip Securiganth P,” manufactured by Atotech Deutschland GmbH (“Securiganth” is a registered trademark)) and 3 g/L of sodium hydroxide, and then rinsed with water.

(Roughening Treatment Step)

Then, the cured product was immersed under shaking for 20 minutes in an aqueous solution at 80° C., which had been prepared by adding water to the mixture of 500 mL of an aqueous solution of permanganate (“Concentrate Compact CP,” manufactured by Atotech Deutschland GmbH) and 40 g of sodium hydroxide to bring the total volume to 1 L, and then rinsed with water.

(Neutralization and Reduction Treatment Step)

Then, the cured product of the laminate was immersed for 5 minutes in an aqueous solution at 40° C., which had been prepared to contain 100 mL/L of an aqueous solution of hydroxylamine sulfate (“Reduction Securiganth P 500,” manufactured by Atotech Deutschland GmbH (“Securiganth” is a registered trademark)) and 35 mL/L of sulfuric acid, subjected to neutralization and reduction treatment, and then rinsed with water.

(Cleaner/Conditioner Step)

Next, the cured product of the laminate was subjected to cleaner/conditioner treatment by being immersed for 5 minutes in an aqueous solution at 50° C., which had been prepared to contain a cleaner/conditioner aqueous solution (“Alcup MCC-6-A,” manufactured by Uyemura & Co., Ltd. (“Alcup” is a registered trademark)) at a concentration of 50 mL/L. Then, the cured product of the laminate was immersed in rinsing water at 40° C. for 1 minute, and was subsequently rinsed with water.

(Soft Etching Treatment Step)

Then, the cured product of the laminate was immersed for 2 minutes in an aqueous solution, which had been prepared to have a sulfuric acid concentration of 100 g/L and contain 100 g/L of sodium persulfate, to be soft-etched, and was subsequently rinsed with water.

(Pickling Treatment Step)

Then, the cured product of the laminate was immersed for 1 minute in an aqueous solution, which had been prepared to have a sulfuric acid concentration of 100 g/L, to be pickled, and was subsequently rinsed with water.

(Catalyst Application Step)

Then, the cured product of the laminate was immersed for 5 minutes in a Pd salt-containing plating catalyst aqueous solution at 60° C., which had been prepared to contain 200 mL/L of Alcup Activator MAT-1-A (trade name, manufactured by Uyemura & Co., Ltd. (“Alcup” is a registered trademark)), 30 mL/L of Alcup Activator MAT-1-B (trade name, manufactured by Uyemura & Co., Ltd. (“Alcup” is a registered trademark)), and 0.35 g/L of sodium hydroxide, and was subsequently rinsed with water.

(Activation Step)

Then, the cured product of the laminate was immersed for 3 minutes in an aqueous solution at 35° C., which had been prepared to contain 20 mL/L of Alcup Reducer MAB-4-A (trade name, manufactured by Uyemura & Co., Ltd. (“Alcup” is a registered trademark)) and 200 mL/L of Alcup Reducer MAB-4-B (trade name, manufactured by Uyemura & Co., Ltd. (“Alcup” is a registered trademark)), to reduce the plating catalyst, and was subsequently rinsed with water.

(Accelerator Treatment Step)

Then, the cured product of the laminate was immersed for 1 minute in an aqueous solution at 25° C., which had been prepared to contain 50 mL/L of Alcup Accelerator MEL-3-A (trade name, manufactured by Uyemura & Co., Ltd. (“Alcup” is a registered trademark)).

(Electroless Plating Step)

The cured product of the laminate thus obtained was immersed, while blowing in air, for 20 minutes in an electroless copper plating solution at 36° C., which had been prepared to contain 100 mL/L of Thru-Cup PEA-6-A (trade name, manufactured by Uyemura & Co., Ltd. (“Thru-Cup” is a registered trademark)), 50 mL/L of Thru-Cup PEA-6-B-2X (trade name, manufactured by Uyemura & Co. Ltd.), 14 mL/L of Thru-Cup PEA-6-C(trade name, manufactured by Uyemura & Co. Ltd.), 15 mL/L of Thru-Cup PEA-6-D (trade name, manufactured by Uyemura & Co. Ltd.), 50 mL/L of Thru-Cup PEA-6-E (trade name, manufactured by Uyemura & Co. Ltd.), and 5 mL/L of a 37% formalin aqueous solution, to be subjected to electroless copper plating to thereby form an electroless plating film on the surface of the cured product of the laminate. Then, the cured product was annealed in an air atmosphere at 150° C. for 30 minutes.

The cured product of the laminate thus annealed was electroplated with copper to form an electroplated copper film having a thickness of 30 μm. Then, the cured product of the laminate with the electroplated copper film formed thereon was heat treated at 180° C. for 60 minutes to thereby obtain a substrate with a conductor layer formed on the surface of the cured product of the laminate, the conductor layer being composed of the thin metal film layer and the electroplated copper film. Then, measurement was conducted on the conductor layer of the obtained substrate to determine the peel strength and heat resistance according to the aforementioned method. The results are presented in Table 1.

In addition, in the cured product of the laminate thus obtained after the annealing at 150° C. for 30 minutes, the electroless plating film was etched with a mixed solution of ferric chloride and hydrochloric acid. After drying, the average surface roughness Ra of the electrically insulating layer was measured according to the aforementioned method. The results are presented in Table 1.

### Example 2

A supported single-layer film, a laminate, a cured product of the laminate, and a substrate were prepared in the same manner as Example 1, except that the amount of the solution of the phosphorus-containing epoxy compound was 90 parts by mass (63 parts by mass in solid content of the epoxy compound).

### Example 3

A supported single-layer film, a laminate, a cured product of the laminate, and a substrate were prepared in the same manner as Example 1, except that the amount of the solution of the phosphorus-containing epoxy compound was 108.1 parts by mass (75.6 parts by mass in solid content of the epoxy compound).

### Example 4

A supported single-layer film, a laminate, a cured product of the laminate, and a substrate were prepared in the same manner as Example 1, except that the amount of the solution of the phosphorus-containing epoxy compound was 126.1 parts by mass (88.2 parts by mass in solid content of the epoxy compound).

### Comparative Example 1

A supported single-layer film, a laminate, a cured product of the laminate, and a substrate were produced in the same manner as Example 1, except that 32 parts by mass of an epoxy resin having a dicyclopentadiene skeleton but containing no phosphorus atoms (EPICLON® HP-7200L, manufactured by DIC Corporation, epoxy equivalent 250 g/eq) was blended in place of the phosphorus-containing epoxy compound.

### Comparative Example 2

A supported single-layer film, a laminate, a cured product of the laminate, and a substrate were produced in the same manner as Example 1, except that 32 parts by mass of an epoxy resin having a dicyclopentadiene skeleton but containing no phosphorus atoms, similar to Comparative Example 1, was blended in place of the phosphorus-containing epoxy compound, and that as a flame retardant, 20 parts by mass of a flame retardant having a phosphaphenanthrene structure, but not having a group reactive with the alicyclic olefin polymer (P-1) (Rabitle® FP-110, manufactured by Fushimi Pharmaceutical Co., Ltd.) was blended.

### Comparative Example 3

A supported single-layer film, a laminate, a cured product of the laminate, and a substrate were produced in the same manner as Example 1, except that 32 parts by mass of an epoxy resin having a dicyclopentadiene skeleton but containing no phosphorus atoms, similar to Comparative Example 1, was blended in place of the phosphorus-containing epoxy compound, and that as a filler, 40 parts by mass of magnesium hydroxide (an inorganic flame retardant, MAGNIFIN® H10, manufactured by Albemarle Japan Corporation) was blended in place of the untreated spherical silica.

TABLE 1

| | | | | | | Comparative | | |
|---|---|---|---|---|---|---|---|---|
| | | Example | | | | Example | | |
| | | 1 | 2 | 3 | 4 | 1 | 2 | 3 |
| Formulation | Alicyclic Olefin Polymer (P-1) | 100 | 100 | 100 | 100 | 100 | 100 | 100 |
| (pts. by | Phosphorus-containing Epoxy | 50.4 | 63 | 75.6 | 88.2 | — | — | — |
| mass) | Compound *1 | | | | | | | |
| | Epoxy Resin with | — | — | — | — | 32 | 32 | 32 |
| | Dicyclopentadiene Skeleton *2 | | | | | | | |
| | Flame Retardant with | — | — | — | — | — | 20 | — |
| | Phosphaphenanthrene Structure *3 | | | | | | | |
| | Inorganic Filler-1 *4 | 40 | 40 | 40 | 40 | 40 | 40 | — |
| | Inorganic Filler-2 *5 | — | — | — | — | — | — | 40 |
| | (Inorganic Flame Retardant) | | | | | | | |
| Equivalent Ratio of Epoxy Group/Polar | | 0.8 | 1 | 1.2 | 1.4 | 1 | 1 | 1 |
| Group (Acid Anhydride Group) | | | | | | | | |
| Phosphorus Content (mass %) | | 0.99 | 1.14 | 1.27 | 1.38 | 0 | 1.73 | 0 |
| Mass of Phosphorus Atoms/Mass of COP | | 1.51 | 1.89 | 2.27 | 2.65 | 0 | 2.68 | 0 |
| (mass %) | | | | | | | | |
| Evaluation | Flame Retardancy | B | A | A | A | C | A | C |
| Results | Heat Resistance | A | A | A | A | A | C | A |
| | Peel Strength | A | A | A | A | A | C | C |
| | Surface Roughness | A | A | B | C | A | C | C |

*1 FX305EK70 (70% methyl ethyl ketone solution, phosphorus content 2 mass %, epoxy equivalent 485 g/eq), manufactured by Nippon Steel & Sumikin Chemical Co., Ltd.
*2 EPICLON HP-7200L (epoxy equivalent 250 g/eq), manufactured by DIC Corporation
*3 Rabitle FP-110, manufactured by Fushimi Pharmaceutical Co., Ltd.
*4 Admafine SO-C1, manufactured by Admatechs Company Limited
*5 MAGNIFIN H10 (magnesium hydroxide, inorganic flame retardant), manufactured by Albemarle Japan Corporation

As is apparent from the results presented in Table 1, the curable resin compositions of Examples 1 to 4, which contain the polar-group containing alicyclic olefin polymer (A1), the phosphorus-containing epoxy compound (A2), and the inorganic filler (A3), are excellent in all of flame retardancy, heat resistance, and peel strength. Among these, regarding flame retardancy, Examples 2 to 4, which contain 60 parts by mass or more of the phosphorus-containing epoxy compound (A2), yield particularly excellent results. Moreover, regarding surface roughness, Examples 1 to 3, which contain 80 parts by mass or less of the phosphorus-containing epoxy compound (A2), show excellent results; among these, Examples 1 and 2, which contain 65 parts by mass or less of the phosphorus-containing epoxy compound (A2), yield particularly excellent results.

On the other hand, Comparative Example 1, which uses an epoxy resin having a cyclopentadiene skeleton in place of the phosphorus-containing epoxy compound (A2), shows poor flame retardancy as compared to Examples 1 to 4.

Comparative Example 2, although it uses an epoxy resin having a cyclopentadiene skeleton in place of the phosphorus-containing epoxy compound (A2), exhibits adequate flame retardancy, since it contains large amounts of a flame retardant having a phosphaphenanthrene structure. However, because of the large flame retardant content, Comparative Example 2 is inferior in heat resistance, peel strength, and surface roughness. That is, Comparative Example 2 could not provide a curable resin composition that is excellent in all of flame retardancy, heat resistance, peel strength, and surface roughness.
As to Comparative Example 3, which uses an epoxy resin having a dicyclopentadiene skeleton in place of the phosphorus-containing epoxy compound (A2), as well as an inorganic filler having a flame retardant effect (an inorganic flame retardant), not only is Comparative Example 3 inferior in flame retardancy as the amount of the flame retardant added is insufficient, but also it is poor in terms of peel strength and surface roughness.

Then, insulating films, each having a plateable layer made of a plateable layer-use resin composition and an adhesive layer made of an adhesive layer-use composition, laminates, cured products of the laminates, and substrates were prepared and evaluated as described below.

### Example 5

### Preparation of Plateable Layer-Use Resin Composition

In this case, 500 parts by mass of a solution of the alicyclic olefin polymer (P-1) obtained in Synthesis Example 1 (100 parts by mass in solid content of the polymer (P-1)), 72 parts by mass of a solution of a phosphorus-containing epoxy compound (an epoxy compound having a phosphaphenanthrene structure, FX305EK70, manufactured by Nippon Steel & Sumikin Chemical Co., Ltd., 70% methyl ethyl ketone solution, phosphorus content 2%, epoxy equivalent 485 g/eq) (50.4 parts by mass in solid content of the epoxy compound), 40 parts by mass of untreated spherical silica (ADMAFINE® SO-C1, manufactured by Admatechs Company Limited, volume average particle size 0.25 μm) as an inorganic filler, 1 part by mass of 2-[2-hydroxy-3,5-bis(α,α-dimethylbenzyl)phenyl]-2H-benzotriazole as a laser processability-improving agent, 1 part by mass of tris-(3,5-di-t-butyl-4-hydroxybenzyl)-isocyanurate (IRGANOX® 3114, manufactured by BASF SE) as an antioxidant, and 0.5 parts by mass of tetrakis(1,2,2,6,6-pentamethyl-4-piperidyl)1,2,3,4-butanetetracarboxylate (ADEKA STAB® LA52, manufactured by ADEKA Corporation) as an antioxidant, were mixed and dispersed in a high-pressure homogenizer.
With this further mixed was 1 part by mass of a 50% solution of 1-benzyl-2-phenylimidazole in anisole as a curing accelerator, and the mixture was stirred with a stirrer for 5 minutes to obtain a varnish of the plateable layer-use resin composition.

(Preparation of Adhesive Layer-Use Resin Composition)

In this case, 100 parts by mass of a dicyclopentadiene-based epoxy resin (EPICLON HP7200HH, manufactured by DIC Corporation, epoxy group equivalent 280g/eq) as the thermosetting resin (B1), 121 parts by mass of an active ester compound (EPICLON HPC-8000-65T, 65 mass % in non-volatile content of a toluene solution, manufactured by DIC Corporation, active ester group equivalent 223 g/eq) as the curing agent (B3) (79 parts by mass of the active ester compound), 35 parts by mass of a solution of the alicyclic olefin polymer (P-2) obtained in Synthesis Example 2 as the curing agent (B3) (7 parts by mass of the alicyclic olefin polymer), 352 parts by mass of silica (SC2500-SXJ, average grain size 0.5 μm, surface-treated with an amino silane coupling agent, manufactured by Admatechs Company Limited) as an inorganic filler, 1 part by mass of a hindered phenol-based antioxidant (IRGANOX3114, manufactured by BASF SE) as an antioxidant, and 110 parts by mass of anisole were mixed and dispersed in a high-pressure homogenizer. With this further mixed was 5.4 parts by mass of a solution of 50 mass % of 1-benzyl-2-phenylimidazole in anisole as a curing accelerator (2.7 parts by mass of the curing accelerator), and the mixture was stirred with a stirrer for 5 minutes to obtain a varnish of the plateable layer-use resin composition.

(Preparation of Supported Insulating Film)

The varnish of the plateable layer-use resin composition obtained in the above process was applied on a polyethylene terephthalate film (support) of 100 μm thick using a wire bar, and then dried for 5 minutes at 85° C. in a nitrogen atmosphere to yield a supported film, on which a 3 μm-thick plateable layer made of the plateable layer-use resin composition in an uncured state was formed.

Then, the varnish of the adhesive layer-use resin composition obtained in the above process was applied, using a doctor blade and an automatic film applicator (both manufactured by Tester Sangyo Co., Ltd.), on the surface of the supported film obtained in the above process on which the plateable layer made of the plateable layer-use resin composition was formed, and then dried in a nitrogen atmosphere at 80° C. for 10 minutes to yield a supported insulating film having a total thickness of 40 μm (the thickness of the plateable layer: 3 μm) on which the plateable layer and the adhesive layer were formed. To obtain the supported insulating film, the support, the plateable layer made of the plateable layer-use resin composition, and the adhesive layer made of the adhesive layer-use resin composition were formed in the stated order. Measurement was conducted on the resulting supported insulating film to determine the flame retardancy according to the aforementioned method. The results are presented in Table 2.

(Preparation of Laminate)

Then, separately from the above, a double-sided copper-clad laminate (an inner substrate) of 0.6 mm thick×125 mm long×125 mm wide was prepared with 18 μm-thick copper being adhered on the surfaces of the core material obtained by impregnating a glass fiber with a varnish containing a glass filler and a halogen-free epoxy resin, and with the copper surfaces being micro-etched by contact with an organic acid.

The supported insulating film obtained in the above process was cut into 125 mm square pieces, which in turn were bonded to both surfaces of the inner substrate, with respective surfaces on the adhesive layer-use resin composition side facing inward (facing the inner substrate), and then subjected to primary press. The primary press is such thermal pressure bonding that is performed in a vacuum laminator equipped with heat-resistant rubber press plates on its bottom and top, under a reduced pressure of 200 Pa, at a temperature of 110° C., a pressure of 0.1 MPa, for a duration of 90 seconds. Furthermore, an oil hydraulic press machine equipped with metallic press plates on its bottom and top was used to perform thermal pressure bonding at a pressure bonding temperature of 110° C., a pressure of 1 MPa, for a duration of 90 seconds. Then, the support was peeled off to yield a laminate of the resin composition layer (the plateable layer and the adhesive layer) made of the resin composition and the inner substrate. Further, the laminate was allowed to stand in an air atmosphere at 180° C. for 60 minutes, causing the resin composition layer to be cured to form an electrical insulating layer on the inner substrate.

Subsequently, after the steps similar to Example 1, swelling treatment step, roughening treatment step, neutralization and reduction treatment step, cleaner/conditioner step, soft etching treatment step, pickling treatment step, catalyst application step, activation step, accelerator treatment step, and electroless plating step, an electroless plating film was formed on the surface of the cured product of the laminate. Then, similar to Example 1, the cured product was annealed in an air atmosphere at 150° C. for 30 minutes.

The cured product of the laminate thus annealed was electroplated with copper to form an electroplated copper film having a thickness of 30 μm. Then, the cured product of the laminate with the electroplated copper film formed thereon was heat treated at 180° C. for 60 minutes to thereby obtain a multi-layer circuit board (a composite) with a conductor layer formed on the surface of the cured product of the laminate, the conductor layer being composed of the thin metal film layer and the electroplated copper film. Then, measurement was conducted on the conductor layer of the obtained circuit board to determine the peel strength and heat resistance according to the aforementioned method. The results are presented in Table 2.

In addition, in the cured product of the laminate thus obtained after the annealing at 150° C. for 30 minutes, the electroless plating film was etched with a mixed solution of ferric chloride and hydrochloric acid. After drying, the average surface roughness Ra of the electrically insulating layer was measured according to the aforementioned method. The results are presented in Table 2.

### Example 6

A supported insulating film, a laminate, a cured product of the laminate, and a substrate were prepared in the same manner as Example 5, except that the amount of the solution of the phosphorus-containing epoxy compound in the plateable layer-use resin composition was 90 parts by mass (63 parts by mass in solid content of the epoxy compound).

### Example 7

A supported insulating film, a laminate, a cured product of the laminate, and a substrate were prepared in the same manner as Example 5, except that the amount of the solution of the phosphorus-containing epoxy compound in the plateable layer-use resin composition was 108.1 parts by mass (75.6 parts by mass in solid content of the epoxy compound).

### Example 8

A supported insulating film, a laminate, a cured product of the laminate, and a substrate were prepared in the same manner as Example 5, except that the amount of the solution of the phosphorus-containing epoxy compound in the plateable layer-use resin composition was 126.1 parts by mass (88.2 parts by mass in solid content of the epoxy compound).

### Comparative Example 4

A supported insulating film, a laminate, a cured product of the laminate, and a substrate were produced in the same manner as Example 5, except that 32 parts by mass of an epoxy resin having a dicyclopentadiene skeleton but containing no phosphorus atoms (EPICLON HP-7200L, manufactured by DIC Corporation, epoxy equivalent 250 g/eq) was blended, in place of the phosphorus-containing epoxy compound, into the plateable layer-use resin composition.

### Comparative Example 5

A supported insulating film, a laminate, a cured product of the laminate, and a substrate were produced in the same manner as Example 5, except that 32 parts by mass of an epoxy resin having a dicyclopentadiene skeleton but containing no phosphorus atoms, similar to Comparative Example 4, was blended, in place of the phosphorus-containing epoxy compound, into the plateable layer-use resin composition, and that as a flame retardant, 20 parts by mass of a flame retardant having a phosphaphenanthrene structure, but not having a group reactive with the alicyclic olefin polymer (P-1) (Rabitle® FP-110, manufactured by Fushimi Pharmaceutical Co., Ltd.) was blended into the composition.

### Comparative Example 6

A supported insulating film, a laminate, a cured product of the laminate, and a substrate were produced in the same manner as Example 5, except that 32 parts by mass of an epoxy resin having a dicyclopentadiene skeleton but containing no phosphorus atoms, similar to Comparative Example 4, was blended, in place of the phosphorus-containing epoxy compound, into the plateable layer-use resin composition, and that as an inorganic filler, 40 parts by mass of magnesium hydroxide (an inorganic flame retardant, MAGNIFIN® H10, manufactured by Albemarle Japan Corporation) was blended, in place of the untreated spherical silica, into the composition.

TABLE 2

| | | | | | | Comparative | | |
|---|---|---|---|---|---|---|---|---|
| | | Example | | | | Example | | |
| | | 5 | 6 | 7 | 8 | 4 | 5 | 6 |
| Formulation | Alicyclic Olefin Polymer | 100 | 100 | 100 | 100 | 100 | 100 | 100 |
| of Plateable | (P-1) | | | | | | | |
| Layer-use | Phosphorus-containing | 50.4 | 63 | 75.6 | 88.2 | — | — | — |
| Resin | Epoxy Compound *1 | | | | | | | |
| Composition | Epoxy Resin with | — | — | — | — | 32 | 32 | 32 |
| (pts. by | Dicyclopentadiene | | | | | | | |
| mass) | Skeleton *2 | | | | | | | |
| | Flame Retardant with | — | — | — | — | — | 20 | — |
| | Phosphaphenanthrene | | | | | | | |
| | Structure *3 | | | | | | | |
| | Inorganic Filler-1 *4 | 40 | 40 | 40 | 40 | 40 | 40 | — |
| | Inorganic Filler-2 *5 | — | — | — | — | — | — | 40 |
| | (Inorganic Flame | | | | | | | |
| | Retardant) | | | | | | | |
| Equivalent Ratio of Epoxy Group/Polar | | 0.8 | 1 | 1.2 | 1.4 | 1 | 1 | 1 |
| Group (Acid Anhydride Group) | | | | | | | | |
| Phosphorus Content (mass %) | | 0.99 | 1.14 | 1.27 | 1.38 | 0 | 1.73 | 0 |
| Mass of Phosphorus Atoms/Mass of COP | | 1.51 | 1.89 | 2.27 | 2.65 | 0 | 2.68 | 0 |
| (mass %) | | | | | | | | |
| Evaluation | Flame Retardancy | B | A | A | A | C | A | C |
| Results | Heat Resistance | A | A | A | A | A | C | A |
| | Peel Strength | A | A | A | A | A | C | C |
| | Surface Roughness | A | A | B | C | A | C | C |

In Table 2, the components *1 to *5 are the same as those presented in Table 1. As is apparent from the results presented in Table 2, the insulating films of Examples 5 to 8, which have plateable layers formed from the plateable layer-use resin compositions containing the polar-group containing alicyclic olefin polymer (A1), the phosphorus-containing epoxy compound (A2), and the inorganic filler (A3), are excellent in all of flame retardancy, heat resistance, and peel strength. Among these, regarding flame retardancy, Examples 6 to 8, which contain 60 parts by mass or more of the phosphorus-containing epoxy compound (A2), yield particularly excellent results. Moreover, regarding surface roughness, Examples 5 to 7, which contain 80 parts by mass or less of the phosphorus-containing epoxy compound (A2), show excellent results; among these, Examples 5 and 6, which contain 65 parts by mass or less of the phosphorus-containing epoxy compound (A2), yield particularly excellent results.

On the other hand, Comparative Example 4, which uses an epoxy resin having a cyclopentadiene skeleton in place of the phosphorus-containing epoxy compound (A2), shows poor flame retardancy as compared to Examples 5 to 8.

Comparative Example 5, although it uses an epoxy resin having a cyclopentadiene skeleton in place of the phosphorus-containing epoxy compound (A2), exhibits adequate flame retardancy, since it contains large amounts of a flame retardant having a phosphaphenanthrene structure. However, because of the large flame retardant content, Comparative Example 5 is inferior in heat resistance, peel strength, and surface roughness. That is, Comparative Example 2 could not provide an insulating film that is excellent in all of flame retardancy, heat resistance, peel strength, and surface roughness.
As to Comparative Example 6, which uses an epoxy resin having a dicyclopentadiene skeleton in place of the phosphorus-containing epoxy compound (A2), as well as a filler having a flame retardant effect (an inorganic flame retardant), not only is it inferior in flame retardancy since the amount of the flame retardant added is insufficient, but also it is poor in terms of peel strength and surface roughness.

1. A curable resin composition comprising:
a polar group-containing alicyclic olefin polymer (A1);
a phosphorus-containing epoxy compound (A2) having a structure represented by formula (1) or (2) below; and
a filler (A3), 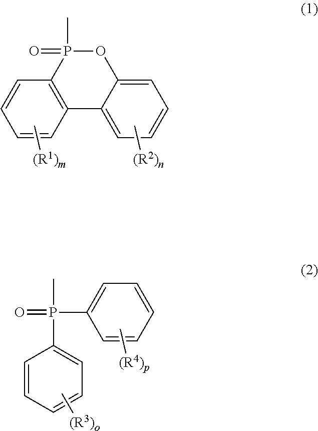
where in the formula (1), R¹ and R² each independently represent a hydrocarbon group having 1 to 6 carbon atoms, and m and n each independently represent an integer of 0 to 4, R¹s may be the same or different when m is 2 or more, and R²s may be the same or different when n is 2 or more, and
where in the formula (2), R³ and R⁴ each independently represent a hydrocarbon group having 1 to 6 carbon atoms, and o and p each independently represent an integer of 0 to 5, R³s may be the same or different when o is 2 or more, and R⁴s may be the same or different when p is 2 or more.

2. The curable resin composition according to claim 1, wherein the phosphorus-containing epoxy compound (A2) is the phosphorus-containing epoxy compound having the structure represented by the formula (1).

3. The curable resin composition according to claim 1, wherein the polar group of the polar group-containing alicyclic olefin polymer (A1) is at least one selected from the group consisting of a carboxyl group, a carboxylic anhydride group, a phenolic hydroxyl group, and an epoxy group.

4. The curable resin composition according to claim 1, wherein the polar group-containing alicyclic olefin polymer (A1) has a polar group reactive with an epoxy structure contained in the phosphorus-containing epoxy compound (A2).

5. The curable resin composition according to claim 1, wherein the content of the phosphorus-containing epoxy compound (A2) is 50 parts by mass to 90 parts by mass per 100 parts by mass of the polar group-containing alicyclic olefin polymer (A1).

6. The curable resin composition according to claim 1, wherein a phosphorus content is 0.8 mass % to 5 mass %, the phosphorus content being expressed as the mass of phosphorus atoms in the curable resin composition divided by the mass calculated by subtracting the mass of the filler (A3) from the mass of solids in the curable resin composition.

7. A cured product formed by curing the curable resin composition as recited in claim 1.

8. An insulating film comprising:
a resin layer 1 made of the curable resin composition as recited in claim 1; and
a resin layer 2 made of another curable resin composition.

9. The insulating film according to claim 8, wherein the resin layer 1 is a plateable layer and the resin layer 2 is an adhesive layer.

10. The insulating film according to claim 8, wherein the resin layer 1 made of the curable resin composition has a thickness of 1 μm to 10 μm, and the resin layer 2 made of the other curable resin composition has a thickness of 5 μm to 100 μm.

11. A prepreg comprising:
a plateable layer made of a plateable layer-use resin composition containing a polar group-containing alicyclic olefin polymer (A1), a phosphorus-containing epoxy compound (A2) having a structure represented by formula (1) or (2) below, and a filler (A3);
an adhesive layer made of an adhesive layer-use resin composition; and
a fibrous substrate, 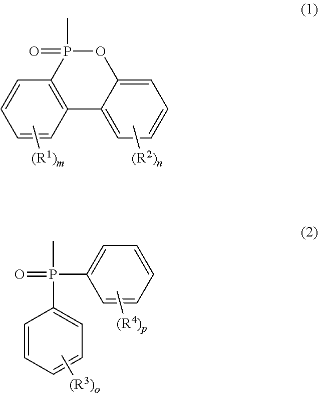
where in the formula (1), R¹ and R² each independently represent a hydrocarbon group having 1 to 6 carbon atoms, and m and n each independently represent an integer of 0 to 4, R¹s may be the same or different when m is 2 or more, and R²s may be the same or different when n is 2 or more, and
where in the formula (2), R³ and R⁴ each independently represent a hydrocarbon group having 1 to 6 carbon atoms, and o and p each independently represent an integer of 0 to 5, R³s may be the same or different when o is 2 or more, and R⁴s may be the same or different when p is 2 or more.

12. A cured product formed by curing the insulating film as recited in claim 8.

13. A composite formed by forming a conductor layer on the surface of the cured product as recited in claim 12.

14. A substrate for electronic material comprising, as a constituent material, the cured product as recited in claim 7.

15. A cured product formed by curing the prepreg as recited in claim 11.

16. A composite formed by forming a conductor layer on the surface of the cured product as recited in claim 15.

17. A substrate for electronic material comprising, as a constituent material, the composite as recited in claim 13

18. A substrate for electronic material comprising, as a constituent material, the composite as recited in claim 16.
